(19) United States
(12) Patent Application Publication
(10) Pub. No.: US 2019/0156426 A1
(43) Pub. Date: May 23, 2019

(54) SYSTEMS AND METHODS FOR COLLECTING AND PROCESSING ALTERNATIVE DATA SOURCES FOR RISK ANALYSIS AND INSURANCE

(71) Applicant: Riv Data Corp., Santa Barbara, CA (US)

(72) Inventors: Max Leslie Drucker, Santa Barbara, CA (US); Geoffrey R. Andrews, Goleta, CA (US)

(21) Appl. No.: 16/252,093

(22) Filed: Jan. 18, 2019

Related U.S. Application Data
(63) Continuation-in-part of application No. 15/546,590, filed on Jul. 26, 2017.
(60) Provisional application No. 62/619,627, filed on Jan. 19, 2018.
(60) Provisional application No. 62/111,996, filed on Feb. 4, 2015.

(51) Int. Cl. G06Q 40/08; G06F 16/951; G06Q 30/00

(52) U.S. Cl. CPC G06Q 40/08; G06Q 30/0185; G06F 16/951

(57) ABSTRACT

Methods and systems generally include a system for collecting and processing data having a crawling system of a computing device for collecting the data from at least one public alternative data site; and an automated data processing system for processing the data collected by the crawling system from the at least one public alternative data site. The automated data processing system is configured to generate at least one risk indicator for use in an insurance system. The data collected by the crawling system is used by the computing device to automatically populate an insurance application and to determine the at least one risk indicator by at least combining data from a plurality of the at least one public alternative data sites.

### CLAIM OF PRIORITY AND CROSS-REFERENCE TO RELATED APPLICATIONS

This application claims priority to U.S. Provisional Patent Application No. 62/619,627, which was filed on Jan. 18, 2018. This application is a continuation-in-part of U.S. patent application Ser. No. 15/546,590, which was filed on Jul. 26, 2017, and published as U.S. Patent Application Publication No. 2018/0018737. U.S. patent application Ser. No. 15/546,590 is a U.S. National Stage entry of International Application No. PCT/US2016/014949, filed on Jan. 26, 2016, which published on Nov. 8, 2016 as WO 2016/126464 and claimed priority to U.S. Provisional Patent Application No. 62/111,996, filed on Feb. 4, 2015. The entire disclosure of each of these applications is hereby incorporated by reference in its entirety as if fully set forth herein.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### TECHNICAL FIELD

The present disclosure relates to risk analysis, and, more particularly, to methods and systems for collecting and processing information from alternative data sources to support various operations of an insurance business.

### BACKGROUND

Insurance businesses depend critically on their ability to assess risk, such as to predict the likelihood and extent of the loss events that they cover in a given type of policy, so that they can set prices appropriately. Insurance companies use risk models that incorporate information known about policyholders to predict levels of risk, pricing models that set prices appropriately given the levels of risk, and other models to support a range of operations across the lifecycle of a policy or claim. The models have been populated by traditional data sources, such as information obtained during the application process (including information reported by applicants, as well as information derived from sources like credit reports and medical histories), information about loss histories of individual and aggregate policyholders, and demographic and actuarial information about a population or group of similar policyholders. Insurance companies face endemic challenges, such as moral hazard (the tendency of policyholders to engage in riskier behavior once insured) and adverse selection (the tendency of riskier policyholders to choose insurance), such that classifying prospective policyholders by their relative risk characteristics is critical to profitability. Also, insurance companies face challenges in setting prices based on risk. If prices are set too high for the level of risk, policyholders will decline to purchase coverage, reducing revenues and profits. If prices are set too low, risky policyholders will purchase too much coverage, resulting in potentially catastrophic loss levels. Accordingly, insurance companies always need improved methods and systems for predicting and assessing risk. Historically, the information about a policyholder's characteristics and behavior has been difficult to obtain outside the application process; however, the Internet has led to a proliferation of information about individuals and businesses. This information includes self-published information, such as social media posts, blogs and the like, as well as business websites, publications and advertising materials. The information also includes information posted by others, such as third-party rating sites, social media sites and postings about individuals by third parties, and many others. The volume of such information is extensive, and the reliability is uncertain, but insurance companies cannot afford to ignore these sources at the risk of missing relevant data for assessing and pricing risk. A need exists for methods and systems for collecting, organizing, processing, and analyzing alternative data sources for the benefit of a wide range of operating activities of insurance companies.

In the case of insurance activities involving individual policyholders, there is a voluminous amount of data publicly available online, with individuals contributing additional data each second. For example, users may provide information via social networking websites, online commerce websites, media sharing websites, news websites, and many other types of mechanisms. However, given the volume of information, the ease of creating “new” web identities, the relative anonymity or lack of verification of data, and other similar reasons, it can be challenging to determine what data may be accurately attributed to a particular individual.

When attempting to evaluate risk associated with an individual, the voluminous information available online, if analyzed properly, could provide valuable insights. Furthermore, these insights may not be available via other means. For these reasons and others, it is desirable to develop a system and method to apply predictive social scoring to perform focused risk assessment. Aspects of the present disclosure fulfill these and other desires.

### SUMMARY

A significant amount of information is available to and needed by businesses, such as insurance providers and the like, to provide competitive and timely services. This includes, among many other types, information that is relevant to assessing risk, such as for underwriting insurance policies, setting prices, determining appropriate coverage amounts, and other activities. Information can be sourced from a range of sources, including the Internet and the like that does not always conform to the technical requirements for providing such services. Additionally, the information available from sources, such as websites and the like on the Internet can be conflicting and/or misleading, often across and within such sources. For effective use of such information, methods and systems are presented herein to, among other things, resolve conflicts, clear up ambiguity, divide and categorize, and quantify non-numeric content (e.g., free form text, descriptive content, images, and the like) so that the information can be used effectively (such as by increasing confidence in risk assessments) when performing services and the like based thereon. One exemplary use of such methods and systems involves generation and/or validation of a risk index associated with an offer for service, such as an insurance service, to target clients and the like. Another exemplary use of such methods and systems involves generation and/or validation of other risk indices, such as indices of risks of certain activities (such as specific business activities), services, or the like, such as the risk involved in a business offering a particular service or product, such as serving alcohol. Other exemplary uses and methods and systems are provided herein for collecting, organizing, processing, and analyzing alternative data sources for the benefit of a wide range of operating activities of insurance companies.

In addition, with the vast range of occurrences of information in such sources and the dynamic nature of the digital world (e.g., the Internet and the like), computer automated methods and systems are provided to mitigate the likelihood that information becomes stale, is unresolved, is incorrectly interpreted, and the like, while providing timely (e.g., near real-time, and the like) delivery of the information to facilitate various processes and services, such as insurance services, processes and the like. In embodiments, to the extent that a business service, such as providing insurance services, uses sophisticated analytic models of real world conditions when determining if and how much to charge for such services, while remaining competitive, providing clarity of such information in a timely manner (e.g., as requested, such as on-demand, or as conditions change and the like) may be crucial for delivering outcomes from the analytic models that reflect not only a specific set of input conditions (e.g., a request for insurance coverage), but a validated view of real world conditions as represented by the diverse sources of information. In other words, merely having access to a wide range of diverse sources of data, such as social media data, website text, Internet images, and the like is far from sufficient to produce a viable risk index for each individual request for a service. Determining meaning and intent of such information, such as through the use of machine learning and the like, in context of an individual request involves solving problems presented by the presence of such diversity of information itself, problems that without this information could not even be formed, yet alone resolved. Yet further, converting this meaning and intent into a quantified value that is suitable for use in providing a given business service (e.g., insurance and the like) requires application technical methods that facilitate determining, for a given inquiry a quantified value (e.g., a number, range, relative measure, and the like) from such non-quantified information as text, images and the like.

The methods and systems herein go even further by facilitating automation of selection of which sources of information to harvest. These source of information selection methods and systems may yield significant improvements in computer capabilities, such as performance and the like, by among other things, limiting the number of websites that must be accessed to gather the information, applying only the computing resources at the optimal times for doing so, avoiding overloading computing servers, such as webservers and the like to further reduce congestion and the resultant retries needed for successful access to the websites and other resources controlled thereby, and the like. With the knowledge of the sources to access and the types of information of value to harvest in those sources, improvements in insurance science (e.g., the analytic models and the like mentioned herein and known in insurance technology, and the like) can be achieved while also reducing the computing resources required to do so.

In embodiments, an insurance data platform is provided that, among other things, uses data from non-traditional, alternative data sources to generate a risk indicator, such as a risk score, from social media and web data for a business, providing unique underwriting insight into the business that cannot be determined using traditional models (such as ones using credit scores). This enables insurers to accurately qualify and price risks, win profitable business, and alleviate the pressure of high losses. References herein to risk scores may refer to one or more measures or indicators of risk, such as calculated based on one or more inputs, such as from one or more alternative data sources or a combination of alternative and traditional data sources, such as providing an overall or aggregated indication of risk, such as associated with a business or individual, a policy element, or the like; however, except where context indicates otherwise, use of the term “risk score” should be understood in connection with various embodiments to encompass any indicator of risk.

In embodiments, the insurance data platform may provide information that assists with streamlining the insurance application process, streamlining insurance claims processing, rating, underwriting and assessing risk, setting rates and prices for insurance policies, assessing accuracy and truthfulness of information provided by policyholders, detecting fraudulent activities, predicting outcomes (including the likelihood, type and scale of potential loss events), classifying items and activities, and others.

Methods and systems are disclosed herein for collecting and processing insurance data and may include a crawling system for collecting data from at least one public alternative data site; and an automated data processing system for processing the data from the alternative data site to facilitate an output risk indicator for use in an insurance system. In embodiments, the alternative data site is at least one of an applicant website, a policyholder website, an applicant social media page, a policyholder social media page, an applicant blog, a policyholder blog, a business rating page regarding an applicant business, a business rating page regarding a policyholder business, a product rating page regarding an applicant product, a product rating page regarding a policyholder product, and an online advertisement by an applicant business.

In embodiments, the risk indicator is produced by combining data from a plurality of the alternative data sites.

In embodiments, the risk indicator is used for at least one of targeting an applicant for a sales effort, underwriting an insurance decision, pricing an insurance policy, and monitoring a claim.

In embodiments, the automated data processing system includes a rules engine for applying at least one rule to the collected data to provide at least one risk indicator relating to at least one of an applicant and a policy holder.

In embodiments, the automated data processing system applies at least one machine learning system to the collected data to provide at least one risk indicator relating to at least one of an applicant and a policy holder.

In embodiments, the automated data processing system applies at least one hybrid processing system consisting of at least one rules engine and at least one machine learning system to provide at least one risk indicator relating to at least one of an applicant and a policy holder.

In embodiments, the risk indicator is a business risk score for a defined category of business and wherein the collected data are processed based on the nature of the category. In embodiments, the category of business is at least one of a restaurant business, a retail business, a hotel business, a bar business, a health business, a fitness business, a beauty business, and a spa business.

In embodiments, the risk indicator is a risk score for a defined category of individual and wherein the collected data are processed based on the nature of the category. In embodiments, the category of individual is at least one of a smoker, a non-smoker, a physically active individual, a disabled individual, an injured individual, an employed individual, and an unemployed individual.

In embodiments, the risk indicator is a risk score for a defined category of insurance and wherein the collected data are processed based on the nature of the category. In embodiments, the category of insurance is at least one of homeowner's insurance, commercial general liability insurance, fire insurance, flood insurance, life insurance, property insurance, health insurance, automotive insurance, motorcycle insurance, boat insurance, and libel insurance.

In embodiments, an application programming interface is provided whereby at least one of a service, an application and a program can subscribe to the system for collecting and processing insurance data to obtain at least one risk indicator. In embodiments, the application programming interface enables a subscriber to subscribe to a stream of risk scores. In embodiments, the application programming interface automatically pushes a risk score based on the presence of a condition. In embodiments, the condition is an indicator of a change in risk that exceeds a threshold.

The methods and systems may be used for fraud detection. In embodiments, the data collected is used to assess the likelihood of fraud by an applicant for insurance. In embodiments, the data collected is used to assess the likelihood of fraud by a policyholder. Except where context indicates otherwise, as used herein, the term “fraud” should be understood to encompass statements, activities, omissions, or the like that are intended to be misleading, whether or not they constitute fraud under a legal definition of the term.

The methods and systems may be used to streamline operations that require a population of data. In embodiments, the data collected is used to populate an insurance application.

In embodiments, according to aspects of the present disclosure, a method for providing a risk assessment recommendation based at least in part on publicly available online information is presented. The method comprises identifying a target subject to be evaluated, searching for and collecting available online information for content about the target subject, validating the collected information, selecting specific features associated with the information, receiving at least one known outcome from a database for at least one specific feature, evaluating the subject data in comparison with the known outcome(s), and providing a risk indicator for the target subject.

According to further aspects of the present disclosure, a system for providing a recommended action for a target subject and specific use case is disclosed. The system comprises one or more processors communicating with an online network, a database in communication with the processor(s), and one or more memory devices storing instructions that, when executed by the processor, cause the system to receive a request pertaining to a target subject and specific use case, search the online computer network for information about the subject, store the information as profile data for the subject, select a plurality of features according to the specific use case, evaluate the profile data in comparison with known outcome information from the database, and determine a recommended action for the target subject and specific use case per the evaluation.

According to further aspects of the present disclosure, a method for determining an insurance quote for a target subject is disclosed. The method includes receiving a request for an insurance quote for a subject, obtaining publicly available data for the subject, verifying the obtained data and storing it as profile data, evaluating the profile data according to a plurality of known outcomes to determine a numerical predictive risk score for the subject, and providing a rate quote for the subject based on the numerical risk score, where a lower risk score is associated with a lower rate quote.

In embodiments, the methods and systems of the present disclosure include methods of producing numeric risk assessments based on free text inputs. A method can include computing with a computing device one or more numeric quantifications of a free text input indicative of risk and deriving with the computing device a numeric risk assessment from the one or more numeric quantification of the free text input.

In embodiments, the method includes converting with the computing device the free text input into criteria. In embodiments, the free text input details a set of conditions indicative of a rate of insurance claim payout.

In embodiments, the method includes numerically assessing with the computing device presences of the criteria in the free text input. In embodiments, the criteria are descriptive of a physical entity and associated conditions that are pertinent for setting a claim payout risk.

In embodiments, the free text input is related to a physical entity. In embodiments, the physical entity comprises at least one of a swimming pool, a hot tub, a pet, a trampoline, a workshop or census data for an address of the physical entity. In embodiments, the free text input is a description of a good or service provided in an environment.

In embodiments, the free text input is related to a property item. In embodiments, the property item is at least one of a swimming pool, a hot tub, a motorcycle, a boat, a deck, a treehouse, a helicopter, a plane, a shed, a workshop, a power tool, or an item of heavy machinery.

In embodiments, the methods and systems of the present disclosure include converting free text data into criteria with a computing device. In embodiments, the free text data describes a set of conditions indicative of a rate of an insurance claim payout and numerically assessing with the computing device presences of the criteria in the free text data descriptive of a physical entity to which the set of conditions is pertinent for setting a claim payout risk.

In embodiments, the free text data is related to the physical entity. In embodiments, the physical entity comprises at least one of a swimming pool, a hot tub, a pet, a trampoline, a workshop or census data for an address of the physical entity. In embodiments, the free text data includes a description of a good or service provided in an environment.

In embodiments, the free text data is related to a property item. In embodiments, the property item is at least one of a swimming pool, a hot tub, a motorcycle, a boat, a deck, a treehouse, a helicopter, a plane, a shed, a workshop, a power tool, or an item of heavy machinery. In embodiments, the method further includes numerically assessing with the computing device presences of the set of conditions in imagery of the physical entity. In embodiments, the imagery is readable by the computing device.

In embodiments, the imagery of the physical entity includes at least one of an image of a swimming pool, a trampoline, a deck, a shed, an item of heavy machinery, a motorcycle, a boat, a workshop or a set of multiple vehicles at an address of the physical entity. In embodiments, the imagery includes at least one image of goods or services pertinent to and provided in an environment.

In embodiments, methods and systems for minimizing loading of web servers. A method includes taking criteria for risk of a claim submission; applying machine learning algorithms seeded with the criteria to determine a set of data sources that exceed a likelihood of containing information relevant to the criteria; and applying an analysis to text and images in a first portion of the set of data sources to generate feedback indicative of network rate load associated with the text and images in the set of data sources. The method further includes applying results of the analysis to a claim risk determining algorithm that produces a first claim risk and a confidence of the first claim risk; and based on the confidence of the first claim risk, repeating the analysis for at least one additional portion of the set of data sources.

The method further includes applying a back-off algorithm for accessing a portion of the set of data sources based on the feedback indicative of the network rate load associated with the text and images in the set of data sources.

In embodiments, the set of data sources includes at least one of a website, web pages, web page types, or web page metadata. In embodiments, a portion of the set of data sources is related to a physical entity. In embodiments, the physical entity comprises at least one of a swimming pool, a hot tub, a pet, a trampoline, a workshop or census data for an address of the physical entity. In embodiments, a portion of the set of data sources includes a description of a good or service provided in an environment related to the physical entity. In embodiments, a portion of the set of data sources is related to a property item associated with the physical entity. In embodiments, the property item is at least one of a swimming pool, a hot tub, a motorcycle, a boat, a deck, a treehouse, a helicopter, a plane, a shed, a workshop, a power tool, or an item of heavy machinery.

In embodiments, methods and systems for optimizing data source selection include a method comprising receiving with a computing device a text-based description of at least one of a physical entity, an environment, a product or a service; and processing the text-based description to produce a plurality of keywords with a real-world keyword generation engine using natural language processing associated with the computing device. In embodiments, the plurality of keywords represents real-world occurrences detectable in data from a plurality of data sources. In embodiments, the plurality of data sources includes text-based sources and image-based sources. The method further includes applying machine learning with the computing device to the plurality of keywords and to feedback from analysis of a portion of the plurality of data sources; and as a result of the machine learning, improving accuracy data source relevance data that details at least one of the physical entity, the environment, the product or the service. The method further includes as a result of the machine learning, identifying candidate data sources that are pertinent to determining one or more risk factors associated with the at least one of the physical entity, the environment, the product or the service; and providing the feedback from the analysis of the portion of the plurality of data sources to a keyword occurrence analysis facility of the computing device. In embodiments, the keyword occurrence analysis facility is configured to be aware of its use of network resources of the computing device and to alter its operation based on its impact on the network resources due to the analysis of the portion of the plurality of data sources. The method further includes producing risk occurrence measures based on results from the providing of the feedback to the keyword occurrence analysis facility and from content found in the portion of the plurality of data sources.

In embodiments, the one or more risk factors are associated with providing a product or service to a customer. In embodiments, the physical entity comprises at least one of a swimming pool, a hot tub, a pet, a trampoline, a workshop or census data for an address of the physical entity. In embodiments, a portion of the plurality of data sources includes a description of a good or service provided in an environment related to the physical entity. In embodiments, a portion of the plurality of data sources is related to a property item associated with the physical entity. In embodiments, the property item is at least one of a swimming pool, a hot tub, a motorcycle, a boat, a deck, a treehouse, a helicopter, a plane, a shed, a workshop, a power tool, or an item of heavy machinery.

In embodiments, methods and systems for determining a likelihood of an existence of a real-world occurrence of a risk factor include a method comprising processing data from at least one source of structured data with a risk criteria occurrence engine of a computing device; processing data from at least one direct source of data with a risk criteria reference engine of the computing device; and processing data from a plurality of sources of data with a corroborative risk occurrence probability engine of the computing device. The method includes processing imagery with an image-based risk criteria engine of the computing device. In embodiments, the imagery is from a plurality of image sources. In embodiments, the processing of the imagery is based on at least one text entry associated with at least one occurrence of a risk detectable in the at least one source of structured data. The method further includes calculating with the computing device a likelihood of at least one corroborated occurrence of risk criteria in the real-world from quantified outputs delivered from the risk criteria occurrence engine, the risk criteria reference engine, the collaborative risk occurrence probability engine and the image-based risk criteria engine.

In embodiments, at least a portion of the imagery is related to a physical entity. In embodiments, the physical entity comprises at least one of a swimming pool, a hot tub, a pet, a trampoline, a workshop or census data for an address of the physical entity. In embodiments, at least a portion of the imagery is related to a description of a good or service provided in a related environment. In embodiments, at least a portion of the imagery is related to a property item. In embodiments, the property item is at least one of a swimming pool, a hot tub, a motorcycle, a boat, a deck, a treehouse, a helicopter, a plane, a shed, a workshop, a power tool, or an item of heavy machinery. In embodiments, the portion of the imagery in a related environment includes at least one of an image of a swimming pool, a trampoline, a deck, a shed, an item of heavy machinery, a motorcycle, a boat, a workshop or a set of multiple vehicles at an address of a physical entity.

In embodiments, methods and systems for computing a risk associated with a product or service offering. A system comprises a risk criteria text analysis engine of a computing device configured to process free form text from a plurality of sources of data. In embodiments, the risk criteria text analysis engine is configured to automatically produce from the free form text at least one measure in criteria indicative of a presence of risk. The system includes a risk criteria image analysis engine of the computing device that automatically processes imagery from the plurality of sources of data. In embodiments, the risk criteria image analysis engine is configured to produce from the imagery at least one measure in the criteria indicative of the presence of risk. The system further includes a text risk criteria presence quantification engine of the computing device that processes the at least one measure in the criteria indicative of the presence of risk in the free form text with a text quantification model associated with the computing device. In embodiments, the text quantification model is selected from a plurality of text quantification models based on aspects of the product or service offering. The system further includes an image risk criteria presence quantification engine of the computing device that processes the imagery readable with the computing device with an image quantification model associated with the computing device. In embodiments, the image risk criteria presence quantification engine automatically determines at least one measure in the criteria indicative of the presence of risk. In embodiments, the image quantification model is selected from a plurality of image quantification models based on aspects of the product or service offering. The system further includes a risk computation engine of the computing device that automatically quantifies occurrences of the image risk criteria by producing a risk factor based on the at least one measures in the criteria indicative of the presence of risk based on the free form text and the imagery from the plurality of sources of data.

In embodiments, at least a portion of the imagery from the plurality of sources of data is related to a physical entity. In embodiments, the physical entity comprises at least one of a swimming pool, a hot tub, a pet, a trampoline, a workshop and census data for an address of the physical entity. In embodiments, at least a portion of the imagery from the plurality of sources of data is related to a description of a good or service provided in a related environment. In embodiments, at least a portion of the imagery from the plurality of sources of data is related to a property item. In embodiments, the property item is at least one of a swimming pool, a hot tub, a motorcycle, a boat, a deck, a treehouse, a helicopter, a plane, a shed, a workshop, a power tool, and an item of heavy machinery. In embodiments, the portion of the imagery from the plurality of sources of data in a related environment includes at least one of an image of a swimming pool, a trampoline, a deck, a shed, an item of heavy machinery, a motorcycle, a boat, a workshop or a set of multiple vehicles at an address of a physical entity.

In embodiments, methods and systems for collecting and processing data. A system includes a crawling system of a computing device for collecting the data from at least one public alternative data site; and an automated data processing system for processing the data collected by the crawling system from the at least one public alternative data site. In embodiments, the automated data processing system is configured to generate at least one risk indicator for use in an insurance system.

In embodiments, the at least one public alternative data site is at least one of an applicant website, a policyholder website, an applicant social media page, a policyholder social media page, an applicant blog, a policyholder blog, a business rating page regarding an applicant business, a business rating page regarding a policyholder business, a product rating page regarding an applicant product, a product rating page regarding a policyholder product, and an online advertisement by an applicant business. In embodiments, the at least one risk indicator is used by the computing device to support at least one of targeting an applicant for a sales effort, underwriting an insurance decision, pricing an insurance policy, and monitoring a claim.

In embodiments, the automated data processing system includes a rules engine. In embodiments, the automated data processing system automatically applies at least one rule to the data collected by the crawling system to automatically determine the at least one risk indicator relating to at least one of an applicant or a policy holder. In embodiments, the automated data processing system of the computing device includes a machine learning system configured to automatically determine at least one risk indicator relating to at least one of an applicant or a policy holder based on the data collected by the crawling system.

In embodiments, the automated data processing system includes at least one hybrid processing system having at least one rules engine and at least one machine learning system that work in concert to determine at least one risk indicator relating to at least one of an applicant or a policy holder. In embodiments, the at least one risk indicator is a business risk score for a defined category of business. In embodiments, the data collected by the crawling system is processed based on a nature of the defined category of business associated with the data. In embodiments, the defined category of business is at least one of a restaurant business, a retail business, a hotel business, a bar business, a health business, a fitness business, a beauty business, or a spa business. In embodiments, the at least one risk indicator is a risk score for a defined category of individual. In embodiments, the data collected by the crawling system is processed based on a nature of the defined category of individual associated with the data. In embodiments, the defined category of an individual is at least one of a smoker, a non-smoker, a physically active individual, a disabled individual, an injured individual, an employed individual, or an unemployed individual.

In embodiments, the at least one risk indicator is a risk score for a defined category of insurance. In embodiments, the data collected by the crawling system is processed based on a nature of the defined category of insurance associated with the data. In embodiments, the defined category of insurance is at least one of homeowner's insurance, commercial general liability insurance, fire insurance, flood insurance, life insurance, property insurance, health insurance, automotive insurance, motorcycle insurance, boat insurance, or libel insurance.

In embodiments, the system includes an application programming interface configured to permit at least one of a service, an application or a program to subscribe to the system for collecting and processing data to obtain the at least one risk indicator. In embodiments, the application programming interface is configured to permit a subscriber to subscribe to a stream of risk indicators. In embodiments, the application programming interface automatically pushes a risk indicator to a user based on a presence of a condition. In embodiments, the condition is an indicator of a change in risk that exceeds a threshold.

In embodiments, the data collected by the crawling system is used by the computing device to automatically assess a likelihood of fraud by an applicant for insurance. In embodiments, the data collected by the crawling system is used by the computing device to assess the likelihood of fraud by a policyholder. In embodiments, the data collected by the crawling system is used by the computing device to automatically populate an insurance application. In embodiments, the computing device determines the risk indicator by at least combining data from a plurality of the at least one public alternative data sites.

These and other capabilities will be more fully understood after a review of the following figures, detailed description, and claims.

### BRIEF DESCRIPTION OF THE DRAWINGS

FIG. 1 depicts components of an insurance data platform and relationships among the components in accordance with the present disclosure.

FIG. 2 depicts a flow involving detection of fraudulent activity by a policyholder of an insurance policy in accordance with the present disclosure.

FIG. 3 illustrates exemplary network data sources for the social scoring process in accordance with the present disclosure.

FIG. 4 illustrates potential factors considered as part of the social score in accordance with the present disclosure.

FIG. 5 is a flowchart of the scoring process in accordance with the present disclosure.

FIG. 6 is a flowchart of an insurance quote process using the social scoring process in accordance with the present disclosure.

FIG. 7 is a partial screen view depicting an example of a portion of a person workbench showing information including name, residential address information, school information, current employer, spouse and the like that may be inserted and/or obtained from a multitude of sources in support of the predictive social scoring process in accordance with the present disclosure.

FIG. 8 is a partial screen view depicting an example of a portion of the person workbench showing information including home value and information, net worth, online presence information and the like that may be inserted and/or obtained from a multitude of sources in support of the predictive social scoring process in accordance with the present disclosure.

FIGS. 9, 10, 11, and 12 are partial screen views depicting examples of portions of the person workbench showing information including relevant images, social media information and the like that may be inserted and/or obtained from a multitude of sources in support of the predictive social scoring process in accordance with the present disclosure.

FIG. 13 is a partial screen view depicting an example of a portion of a business workbench showing information including business name, business address information, and the like that may be inserted and/or obtained from a multitude of sources in support of the predictive social scoring process in accordance with the present disclosure.

FIG. 14 is a partial screen view depicting an example of a portion of the business workbench showing information including business hours, business metrics, a loss propensity score, a business online presence score, an amount of data points considered, a number of sources from which the information displayed was found, and the like in support of the predictive social scoring process in accordance with the present disclosure.

FIG. 15 is a partial screen view depicting an example of a portion of the business workbench showing information including government database information, employee and employment information of the business, and the like that may be inserted and/or obtained from a multitude of sources in support of the predictive social scoring process in accordance with the present disclosure.

FIG. 16 is a partial screen view depicting an example of a portion of the business workbench showing information including commercial eligibility for serving alcohol and the like that may be inserted and/or obtained from a multitude of sources in support of the predictive social scoring process in accordance with the present disclosure.

FIGS. 17, 18, 19, and 20 are partial screen views depicting examples of portions of the business workbench showing information including relevant images, social media information and the like that may be inserted and/or obtained from a multitude of sources in support of the predictive social scoring process in accordance with the present disclosure.

FIG. 21 is a partial screen view depicting an example of a portion of the business workbench showing information including risk analysis information that relates to a business that may be inserted and/or obtained from a multitude of sources in support of the predictive social scoring process in accordance with the present disclosure.

FIG. 22 is a partial screen view depicting an example of a portion of the business workbench showing information including web results that relate to the business that may be inserted and/or obtained from a multitude of sources in support of the predictive social scoring process in accordance with the present disclosure.

FIGS. 23, 24, 25, and 26 are partial screen views depicting examples of portions of an internal analyst claims workflow showing information including loss propensity information, relevant images, social media information, possible fraud indications, and the like that may be inserted and/or obtained from a multitude of sources in support of the predictive social scoring process in accordance with the present disclosure.

FIGS. 27, 28, and 29 are partial screen views depicting examples of portions of finished claims report showing information including subject information, loss event information, social interests, flagged content, and the like that may be reviewed from a multitude of sources in support of the predictive social scoring process in accordance with the present disclosure.

FIG. 30 is a block diagram of alternative data collection and expected outcomes in accordance with the present disclosure.

FIG. 31 is a block diagram of a system for automated source selection in accordance with the present disclosure.

FIG. 32 is a flowchart of reduced computing resource loading for data harvesting in accordance with the present disclosure.

FIG. 33 is a block diagram of a system for quantifying harvested unquantified content in accordance with the present disclosure.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there are shown in the drawings and will herein be described in detail embodiments of with the understanding that the present disclosure is to be considered as an exemplification of the many aspects of the disclosure and the embodiments illustrated. For purposes of the present detailed description, the singular includes the plural and vice versa (unless specifically disclaimed); the words “and” and “or” shall be both conjunctive and disjunctive; the word “all” means “any and all;” the word “any” means “any and all;” and the word “including” means including without limitation.” Additionally, the singular terms “a,” “an,” and the include plural referents unless context clearly indicates otherwise.

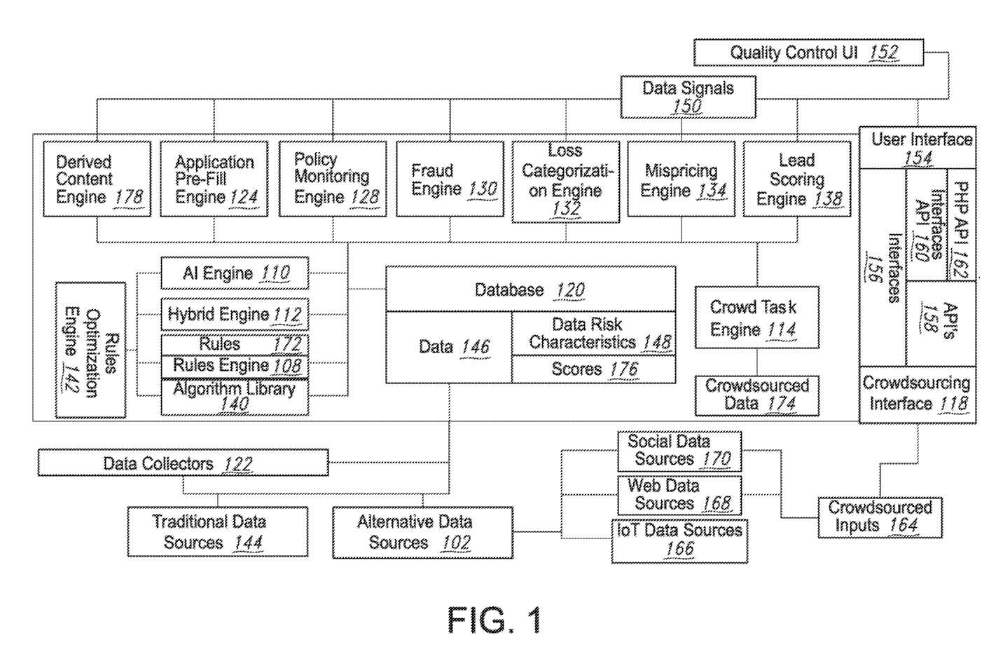

FIG. 1 depicts an information technology insurance data platform 100 with a variety of systems, components, workflows, processes, methods, modules, services, interfaces 156, and other elements (collectively referred to herein as the “insurance data platform,” the “insurance platform,” or, for ease of reference, simply the “platform”) for supporting the operations of the insurance provider and the various entities that interact with or within the insurance provider or support its operations, including actuaries, underwriters, regulators, rate-makers, ratings agencies, prospective and actual policyholders, secondary insurers, risk assessors, agents, brokers, and others. References throughout this disclosure to policyholders should be understood to encompass both prospective and actual policyholders, except where context indicates otherwise.

The insurance data platform may, among other things, support operations relating to methods and systems for applying for the insurance policy (including improved interfaces and automated data collection processes for streamlining the application process), methods and systems for streamlining insurance claims processing, methods and systems for rating, underwriting and assessing risk associated with issuance of a policy to a given policyholder or class or group of policyholders, methods and systems for setting rates and prices for insurance policies, methods and systems for assessing accuracy and truthfulness of information provided by policyholders, methods and systems for detecting fraudulent activities, methods and systems of predicting outcomes (including the likelihood, type and scale of potential loss events), classifying items and activities (such as to place a person or a business in a particular category, and others.

Among other important capabilities, the insurance data platform may include capabilities for collection, processing, and utilization of a much broader range of data sources than historically contemplated by insurance providers, which are referred to herein as “alternative data sources” 102 and which may encompass a wide range of sources, such as rating websites, social media sites, e-commerce sites, media sites, and others that provide information and insight into one or more characteristics of a prospective or actual policyholder. References in this disclosure to the insurance data platform should be understood, except where context indicates otherwise, to encompass any and all such operations, as illustrated according to the exemplary and non-limiting embodiments set forth herein or as would be understood by one of ordinary skill in the art.

In embodiments, the insurance data platform may automate collection of data from alternative data sources 102. These alternative data sources 102 may be selected from at least one of social media data sources and website data sources, which may include data sources that provide ratings of products or services, websites that provide business ratings, electronic commerce websites, websites of businesses (including actual and prospective policyholders), personal social media pages (e.g., Facebook™), social media communication platforms (e.g., Snapchat™ and Instagram™), dating and meeting websites (e.g., Tinder™, eHarmony™ and the like), teamwork and scheduling websites (such as for scheduling sporting events, performance events and the like), and a wide variety of others.

These alternative data sources 102 provide a variety of streams of information about applicants and policyholders that can provide insight about their characteristics, their activities, their propensity for risks of various types, the likelihood of a loss of a given type, the likely scope or scale of a given type of loss, and the like. As a simple example among many, photographs on a social media page may show an applicant smoking, indicating that the application should be flagged as a smoker in an insurance application and handled as a smoker for underwriting and pricing purposes.

The platform 100 may include methods, systems, components, services, interfaces, modules, and other capabilities for processing alternative data sources 102, alone and in combination with traditional sources (such as information obtained via an insurance application process, such as a health history, a property assessment, credit score, or the like), which may include automated processing systems 104, which may include rule-based processing, such as by a rules engine 108, processing by machine learning and artificial intelligence, such as by an artificial intelligence (AI) engine 110, processing by a hybrid engine 112 that combines rule-based processing with artificial intelligence/machine learning, and/or processing that facilitates or automates information contributions of humans, such as facilitated by a crowd task engine 114 that manages interactions with a distributed crowd of individuals who, by interacting with one or more crowdsourcing interfaces 118 of the platform 100, may provide insight regarding the content or meaning of some aspect of one or more of the alternative data sources 102.

The insurance data platform may collect data 146 from a wide variety of data sources. Data sources may include social and web data sources 168, alternative data sources 102 and Internet of Things (IoT) data sources, for example. IoT data sources 166 may include IoT devices including IoT devices from Fitbit™, Google™, Withings™, Jawbone™, Nest™ SmartThings™, Roost™, Link™, Wally™ and Leaksmart™. The insurance data platform may then process the data 146 and provide the data 146 to insurance companies (also referred to herein as “carriers”). In embodiments, the data 146 can be summarized, fused with other data sources, or used in the calculation of scores 176, so that the carriers may receive not only raw data in batch form, in streams, or available to be pulled via one or more application programming interfaces (API's) 158, but also scores 176, metrics, and other forms of information from the platform 100.

The platform 100 may also provide a variety of interfaces 156 and tools for the carriers, including through the API's 158, by which the carriers may have access to the data 146, scores 176, and the like that are collected or managed by the platform 100. These scores 176, the data 146, the interfaces 156 and tools may provide the insurance carrier with quick, useful and high-level insight information into the entire online presence of a person or entity. The insight and information may be made available through a variety of formats. These formats may include PDF export, the API's 158 (by which one or more applications, services, programs, or the like may extract the information by a query, a request for a file or collection of files, or subscription to a stream of information), nightly batch uploads and downloads, and the like. The insight information may also be stored for future reference, such as in the cloud or in a distributed storage system.

The insurance data platform may be used throughout the entire life cycle of an insurance product or claim. A product or claim life cycle may include product development activities (such as determining what items or activities should be covered, what items or activities should be excluded from coverage, what levels of deductible should be applied, and the like), marketing activities (such as targeting particular types of policyholder for sales and marketing activities), pricing activities (such as determining appropriate pricing based on predictions of the likelihood and extent of losses and/or presenting information to rate-makers, regulators, and the like to validate the appropriateness of pricing levels), quoting activities, policy issuance activities, underwriting activities, claim filing activities, policy renewal activities and overall portfolio management activities. Marketing activities may include lead scoring and policy acquisition activities. Quoting activities may include offering incentives and fast track purchasing options. Policy issuance activities may include accelerated underwriting and report avoidance activities. Claim filing activities may include fast track payments and investigation avoidance activities. Policy renewal activities may include offering discounts and report avoidance activities.

The insurance data platform may use or include a database 120. The database 120 may be a SQL database, a NoSQL database, a relational database, an object-oriented database, and the like. The database 120 may include the data 146 and data risk characteristics 148. The database 120 may be a distributed database and may consist of one or more logical or physical databases (including by use of one or more virtual machines) located in one or more locations, including using cloud platform infrastructure.

The database 120 may store and manage the data 146 collected via various data collectors 122 (including web crawlers, spiders, agents, brokers, connectors, bridges, and other data integration elements) from the alternative data sources 102, from traditional data sources 144 (such as involved in the application process, including information from applicants and third parties, as well as information from models, such as actuarial models), from interaction of various users with the API's 158 and the interfaces 156 of the platform 100 and from crowdsourcing, as well as information collected from the outputs and activities of the various engines and other components of the platform, such as the rules engine 108, the AI engine 110, the hybrid engine 112, the crowd task engine 114, and the like.

The database 120 may connect to, integrate with and/or support the processing components of the platform 100, such as the traditional data sources 144, alternative data sources 102, data collectors 122, a library of algorithms 140, the rules engine 108, AI engine 110, the hybrid engine 112, the crowd task engine 114, a derived content engine 178, an application pre-fill engine 124, a policy monitoring engine 128, a fraud engine 130, a loss categorization engine 132, a mispricing engine 134, and a lead scoring engine 138.

The library of algorithms 140 may connect to, be integrated with, and support the various engines and components of the platform 100, including a rules optimization engine 142, the rules engine 108, the hybrid engine 112, the AI engine 110, the derived content engine 178, the application pre-fill engine 124, the policy monitoring engine 128, the fraud engine 130, the loss categorization engine 132, the mispricing engine 134, the lead scoring engine 138 and crowd task engine 114.

The rules engine 108 may store and execute various rules 172. The rules engine 108 may also connect, integrate with, or support the rules optimization engine 142, the library of algorithms 140, the hybrid engine 112, the AI engine 110, the derived content engine 178, the application pre-fill engine 124, the policy monitoring engine 128, the fraud engine 130, the loss categorization engine 132, the mispricing engine 134, the lead scoring engine 138 and the crowd task engine 114.

In exemplary and non-limiting embodiments, algorithms included in the library of algorithms 140 may be composed of sets of the rules 172 provided by the rules engine 108 and the hybrid engine 112. Algorithms may implement logic based on the rules 172, determine outcomes based on the rules 172, make recommendations based on the rules 172 and the like. Algorithms may also be optimized or otherwise improved upon using feedback from the rules optimization engine 142 and AI engine 110. These improvements may be further enhanced by inputs provided by the other engines. These improvements may then improve the accuracy of predictions made by the AI engine 110, the correctness of decisions made by the rules engine, and the like, which in turn may improve the quality of decisions made by the carriers, for example. The AI engine 110 may also connect to the rules optimization engine 142, the library of algorithms 140, the rules engine 108, the hybrid engine 112, the derived content engine 178, the application pre-fill engine 124, the policy monitoring engine 128, the fraud engine 130, the loss categorization engine 132, the mispricing engine 134, the lead scoring engine 138 and the crowd task engine 114, in order to support the insurance platform as discussed throughout this disclosure.

The rules 172 may also be used to automate or otherwise improve upon carrier processes that rely on data inputs. Data input processes in their current form are time-consuming and prone to error. In the following exemplary and non-limiting embodiments, automation and other improvements made possible by the rules 172 from the rules engine 108 may improve the data input process, by making it faster and more accurate.

For example, in exemplary and non-limiting embodiments, the insurance data platform may accelerate a claims process by automatically presenting the data 146 required by an insurance adjuster that has been distilled from alternative data sources 102, bypassing the need for an adjuster to search for, collect and manually input the required data 146.

In further exemplary and non-limiting embodiments, the insurance data platform may automatically present the data 146 to answer a question. The data 146 may be presented if, for example, confidence in the answer to the question exceeds a threshold, based on output from the rules engine 108 or machine learning system, such as the AI engine 110.

The rules engine 108 may process data collected from alternative data sources 102 in order to determine a measurement of the propensity for risk of a policyholder, also referred to in this disclosure as a risk propensity measurement. The rules engine 108 may also include a system, for example, the rules optimization engine 142, for learning and building a statistical model on a training set of known insurance outcomes, for example a training set of 50,000 known outcomes validated by real-world cases. The rules engine 108 may use the known outcomes and data collected from the alternative data sources 102, to train the AI engine 110 to determine the risk propensity measurement, increasing the accuracy of the measurement.

The rules engine 108 may also be applied to the output of the rules optimization engine 142, in order to provide supervisory feedback and improve the outcomes of the rules optimization engine 142. In exemplary and non-limiting embodiments, the AI engine 110 may generate leads and other searchable information to enrich the rules optimization engine 142.

The application pre-fill engine 124 may also connect to the derived content engine 178, the AI engine 110, the hybrid engine 112, the rules engine 108, algorithms, the policy monitoring engine 128, the fraud engine 130, the loss categorization engine 132, the mispricing engine 134, the lead scoring engine 138, the crowd task engine 114 and data signals 150. As mentioned previously, the hybrid engine 112 may use a combination of the rules 172 and artificial intelligence (AI) to provide feedback to algorithms, improving the decisions made by the algorithms. The combination of the rules 172 and AI may be advantageous in exemplary and non-limiting embodiments, as the combination may allow manual rule inputs to be provided by the carrier, then improved upon by AI methods. The hybrid engine 112 may also connect to the rules optimization engine 142, the library of algorithms 140, the rules engine 108, the AI engine 110, the application pre-fill engine 124, the policy monitoring engine 128, the fraud engine 130, the loss categorization engine 132, the mispricing engine 134, the lead scoring engine 138 and the crowd task engine 114.

The policy monitoring engine 128 may also connect to the AI engine 110, the hybrid engine 112, the rules engine 108, algorithms, the derived content engine 178, the application pre-fill engine 124, the fraud engine 130, the loss categorization engine 132, the mispricing engine 134, the lead scoring engine 138, the crowd task engine 114 and the data signals 150. The policy monitoring engine 128 may monitor policies and policyholder data for the data 146, events and other types of information that may inform functions of the other engines. For example, the data 146 may be used to improve machine learning outcomes provided by the AI engine 110 to the rules engine 108. Events may include events indicating a policy violation, policy usage or policy activity that indicates rewards or incentives may be provided to a policyholder.

The fraud engine 130 may also connect to the AI engine 110, the hybrid engine 112, the rules engine 108, algorithms, the derived content engine 178, the application pre-fill engine 124, the policy monitoring engine 128, the loss categorization engine 132, the mispricing engine 134, the lead scoring engine 138, the crowd task engine 114 and the data signals 150. The fraud engine 130 may, for example, identify indications of fraud, based on inputs received from the other engines, and receive inputs from the other engines, for example the AI engine 110 and the hybrid engine 112, to improve fraud detection capabilities.

The loss categorization engine 132 may also connect to the AI engine 110, the hybrid engine 112, the rules engine 108, algorithms, the derived content engine 178, the application pre-fill engine 124, the policy monitoring engine 128, the fraud engine 130, the mispricing engine 134, the lead scoring engine 138, the crowd task engine 114 and the data signals 150. In exemplary and non-limiting embodiments, the loss categorization engine 132 may analyze loss events using the data 146 provided by the other engines, for example loss events due to fraud provided by the fraud engine 130, as well as improve loss ratios, for example by receiving data from the crowd task engine 114, indicating a required update to the lead scoring engine 138, that is then used by the mispricing engine 134 to identify a policy that may be priced lower than had the input from the crowd task engine 114 not been received.

The mispricing engine 134 may also connect to the AI engine 110, the hybrid engine 112, the rules engine 108, algorithms, the derived content engine 178, the application pre-fill engine 124, the policy monitoring engine 128, the fraud engine 130, the loss categorization engine 132, the lead scoring engine 138, the crowd task engine 114 and the data signals 150. The mispricing engine 134, in addition to the example mentioned previously, may identify data that indicates a policy is mispriced. The mispricing engine 134 may indicate a policy price should be increased, for example if the alternative data sources 102 include a picture of a policyholder smoking, however, the policyholder indicated that they are a non-smoker. The mispricing engine 134 may also indicate a policy price should be decreased, for example if inputs provided by the policy monitoring engine 128 indicate that a policyholder has not filed a claim within the past 5 years.

In further exemplary and non-limiting embodiments, the insurance data platform may generate a score 176 estimating the likelihood a policyholder is a smoker that may be provided to insurance policy underwriters. A smoker score 176 may be generated using a combination of natural language processing and machine learning, such as machine learning provided by the AI engine 110.

Natural language processing and machine learning may process online activity data collected from alternative data sources 102 relating to objective data about a policyholder. Online activity data may include a number of social media connection, for example LinkedIn™ connections, Tweets™, content of Tweets™, number email addresses, number of phone carriers and content of web pages. For example, the AI engine 110 may indicate that policyholders with greater online presences are less likely to smoke than policyholders with more limited online presences.

The lead scoring engine 138 may also connect to the AI engine 110, the hybrid engine 112, algorithms, the derived content engine 178, the application pre-fill engine 124, the policy monitoring engine 128, the fraud engine 130, the loss categorization engine 132, the mispricing engine 134, the crowd task engine 114 and the data signals 150. The lead scoring engine 138 may receive inputs from the other engines, for example the AI engine 110 and the hybrid engine 112, to improve the accuracy of lead scores 176. The lead scoring engine 138 may also provide inputs to other engines, for example the mispricing engine 134, to identify trends in mispriced policies based on scores 176 generated by the lead scoring engine 138.

The derived content engine 178 may also connect to the data signals 150. The derived content engine 178 may mine text and other data, such the data 146, from websites using natural language processing, regular expressions, and other techniques to determine whether a given entity may be engaged in a certain activity or may offer a specific type of service.

In further exemplary and non-limiting embodiments, as part of a risk scoring activity related to a commercial insurance policy for a restaurant, where a fire is a potential loss event, the platform 100 may identify the menu of a restaurant and interrogate the menu to determine if the restaurant offers foods that may be commonly prepared using a deep fryer. If the platform 100 determines that the restaurant does offer foods that may be commonly prepared using a deep fryer, the derived content engine 178 may then generate a code, flag, score, indicator, or other output identifying that the restaurant has a deep fryer, ensuring that this information is taken into consideration when the risk is being priced or underwritten, for example by the lead scoring engine 138. A risk score may be developed by accumulating a collection of such inputs, including ones that relate to likelihood of loss and ones that relate to the likely damage in the event of the loss. The inputs may be operated upon by one or more rules, may be used in one or more models (such as where given inputs are weighted to reflect individual or combined impacts on the likelihood or extent of loss) and/or may be used as inputs in the AI engine 110, such as one that classifies items or activities, makes predictions, and the like.

The crowd task engine 114 may also connect to the AI engine 110, the hybrid engine 112, the rules engine 108, algorithms, the derived content engine 178, the application pre-fill engine 124, the policy monitoring engine 128, the fraud engine 130, the loss categorization engine 132, the mispricing engine 134, the lead scoring engine 138, task engine and crowd sourced data 174. The crowd task engine 114 may receive the crowd sourced data 174 and provide the crowd sourced data 174 as inputs to the other engines. For example, the crowd sourced data 174 may provide a picture of policyholder smoking, verified by a crowd sourced input, to the fraud engine 130, indicating fraudulent activity, if the policyholder indicated they were a non-smoker. The crowd task engine 114 may receive inputs from the other engines, for example an unverified image of a policyholder smoking from the fraud engine 130, requesting the image be validated by crowd sourced input. The crowd task engine 114 may allocate tasks based on recognizing missing information (such as whether or not an individual has been identified as a smoker or non-smoker on an application), recognizing uncertainty or ambiguity, such as where there is conflicting information from automated sources that can be disambiguated, and the like.

In exemplary and non-limiting embodiments, the insurance data platform may send a set of claim-related uniform resource locators (URLs) or other data, such as the data 146, as well as a question about how to interpret the data 146, to a large group of people, also referred to as a “crowd”, and request the crowd to review the data 146 and provide an answer or answers to the question through the crowdsourcing interface 118. The answer or answers to the question may be provided through the crowdsourcing interfacing 118 and converted to the crowd sourced data 174. The crowd sourced data 174 may then be sent by the crowd task engine 114 to the fraud engine 130 and be used by the fraud engine 130 to identify the likelihood of a claim being fraudulent.

The crowd task engine 114 may be used to allocate tasks to a crowd that are used to create a training set of data for the AI engine 110 or hybrid engine 112, such as having a crowd of users look at restaurant menus to determine a type of restaurant, having a crowd of users look at photographs of a business to determine the type of business, having a crowd of users look at social media pages to assess the activities in which an individual engages or the places where an individual travels, and many others.

In exemplary and non-limiting embodiments, the insurance data platform may provide a score 176 to measure the likelihood a claimant is ready to return to work after filing a claim. A claim may be a disability claim filing, workers' compensation claim filing or bodily injury claim filing, for example. For example, if a claimant's social media presence shows a high level of physical activity, such as hiking, participation in competitive sports, and the like, system may provide the score 176 that indicates readiness to return to work.

The insurance data platform may also use the score 176 to direct a claimant to return to work if the score 176 exceeds a threshold. The score 176 may also be provided to underwriters of insurance policies in order to contribute to a measure of current activity of an insured/policyholder that may be calculated by the underwriters.

The insurance data platform 100 may include an activity level as an input, when computing the score 176 to measure the likelihood a claimant is ready to return to work after filing a claim. The score 176 may be calculated by the rules engine 108 that uses input from the alternative data sources 102. For example, the insurance data platform may seek to identify claimants who are more active than they say they are, by analyzing the social data sources 170. Similarly, the score 176 may indicate policyholders who are less active than they say they are, such as where health, life, or disability insurance is provided at pricing that is based in part on an individual's engaging in high levels of activity associated with a healthy lifestyle, when the individual is in fact relatively sedentary.

The insurance data platform 100 may include the interfaces 156. The interfaces 156 may include a user interface 154 and the crowdsourcing interface 118. The user interface 154 may allow users, such as carriers, access to the data made available by the insurance platform, as well as provide data to the insurance platform. Data may be made available by the insurance platform in the form of the data signals 150.

The user interface 154 may present the data signals 150 to the carriers for review, analysis and refinement. The user interface 154 may also receive data from the carriers, in order to process it in accordance with the methods described within this disclosure. For example, the carrier may use a quality control user interface 152 to review and analyze preliminary results provided by the insurance platform, then receive inputs from the user to refine the preliminary results.

A data signal may include an indication. A data signal indication may signal how a user should interpret or otherwise act upon a data signal. For example, the fraud engine 130 may provide an input to a data signal indicating a fraudulent claim. In this example, the data signal indicating fraud may display an alert to a carrier that a fraudulent claim has been detected and recommend the claim be reviewed by the carrier to confirm that the claim is a fraudulent one.

Interfaces 156 may also include application programming interfaces (API's) 158. The API's 158 may include a PHP API 162, underwriter API 160 and the like. The API's 158 may allow users, such as the carriers, to communicate with the insurance platform via machine-to-machine communication, in order to exchange data directly between systems, without requiring human interaction. API's may be provided in a server scripting language like PHP, a general purpose programming language like Python, or other suitable programming languages that facilitates ease-of-access to streams of information, such as risk scores and indicators, from the insurance platform, by outside systems, applications, services, and the like.

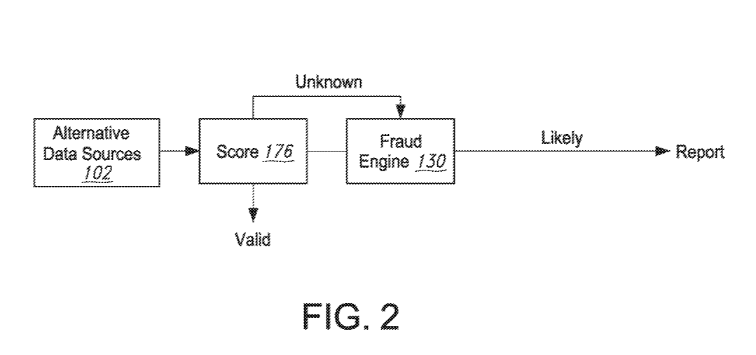

As depicted in FIG. 2, in additional exemplary and non-limiting embodiments, the insurance data platform may use the score 176 to automatically identify claims fraud. Referring to FIG. 2, the score 176 may indicate that a claim is valid. The score 176 may also indicate the validity of a claim to be unknown and send the claim to the fraud engine 130 for additional analysis. The fraud engine 130 may indicate the claim is likely to be fraud, for example, by determining that 2-5% of the data contradicts the identified claim and report the claim as likely to be fraudulent as a result of the determination.

In embodiments, the platform 100 is used to generate a risk score from social media and web data for a business, providing unique underwriting insight into the business that cannot be determined using traditional models (such as ones using credit scores). This enables insurers to accurately qualify and price risks, win profitable business, and alleviate the pressure of high losses. A risk score may be provided for each specific type of business, accounting for the unique types of loss event most typically associated with such a business, and the likelihood and extent of such losses. For example, a distinct business risk score may be provided for a retailer (such as identifying information that may suggest a likelihood of theft or other crimes), a restaurant (such as information that may suggest a risk of a fire or a legal claim for food poisoning), a beauty and spa business, a health and fitness business, an auto repair business, a bar or club business (such as information that may indicate the likelihood of a problem resulting from sale of alcohol), a travel business, a hotel or other hospitality business, or the like.

The disclosure herein also provides capabilities to collect, analyze, and apply electronic information that is publicly available online. Using these capabilities, the system and method disclosed herein can be applied to a risk management decision process, such as insurance quotations and/or underwriting, and provide a recommended action. As detailed further below, the process includes identifying a potential subject and collecting online content potentially relating to that subject. Next, a verification mechanism, such as the Social Intelligence® Identity Resolution Engine 306 is used to validate data potentially relating to the subject. Then, the validated data is analyzed using a predictive scoring process, leading to a final determination of risk for the potential subject. In some embodiments, the final determination is expressed as a “green light” report, where a green light indicates a good risk that does not require further investigation, and a red light indicates an undesirable risk that, at a minimum, requires further investigation.

In some embodiments, the disclosure herein may be applied to the insurance application process. For example, a subject applying for insurance, such as car insurance, can be analyzed using the system and methods herein, which will identify the subject as either a good risk that can be quickly processed, or an unknown risk that requires further investigation, such as a credit check, motor vehicle report, claim history, and/or other types of additional data before accepting the application. In other embodiments, the disclosure may be applied to other types of insurance, such as home insurance, life insurance, umbrella policies, and other types of insurance policies.

In still other embodiments, the disclosure may be applied to many other situations where the risk or credibility of a subject requires evaluation. For example, the disclosure may assist with employment background checks, litigation support, corporate investigations, vendor screening, and many other applications where it is desirable to identify and/or avoid high-risk subjects. According to some embodiments, the predictive scoring capabilities may be applied to loan applications or other lending analysis.

According to embodiments where the risk analysis is related to a financial instrument, such as an insurance policy or a loan, the payment required by the applicant can be varied according to the predictive score for the applicant. In some embodiments, the predictive scoring determination is expressed according to a numeric range or other scale of relative risk scores. For example, according to some embodiments, a low risk applicant may be identified as an “A” and a higher risk applicant may be identified as a “C,” with an extremely high risk applicant identified as an “F.” Furthermore, the applicable payment terms, for example, an insurance premium or interest rate, can be adjusted such that an applicant rated “A” pays a slightly lower amount than an applicant rated “B.”

The voluminous amount of publicly available online information may provide data relating to a subject's financial status, arrest record, drug use, driving history, purchasing behavior, consumer sentiment, social connections, life events, and many other areas. A traditional analysis, such as analyzing a subject's credit history and motor vehicle records in order to evaluate insurance risk, provides a limited picture of a subject's risk profile. The expanded analysis disclosed herein, using social media and other online information to evaluate risk, provides access to data not previously available and potentially presents a better picture of a subject's potential risk.

The system and method for predictive social scoring disclosed herein can be performed using one or more processors directly or indirectly connected to an online network, such as the Internet. The one or more processors are configured to communicate with a tangible machine-readable storage media including instructions for performing the operations described herein. Machine-readable storage media includes any mechanism that stores information and provides the information in a form readable by a processor. For example, machine-readable storage media includes read only memory (ROM), random access memory (RAM), magnetic-disk storage media, optical storage media, flash memory, etc. The one or more processors are configured to accept input from an input device, such as a keyboard, mouse, touchscreen, or other input mechanisms, and provide output via an output device such as a display, printer, speaker, or other output mechanisms. The one or more processors may be part of a desktop computer, laptop, server, mobile phone, tablet, or other devices with sufficient processing power, input/output capabilities, and connectivity to perform the operations described herein. In some embodiments, the one or more processors may be distributed across multiple devices to improve processing speed and/or accessibility.

According to some embodiments, the one or more processors communicatively coupled to a local database with data detailing known outcomes, based on actual risk data from validated subject content. In other embodiments, the database is a remote or network database available over an online network, such as an intranet or the Internet. Additionally, the database may be updated based on additional information from actual use cases. For example, in the automotive insurance context, an actual loss claim (for example, a car accident) for an existing subject may be used to further refine the social scoring process, as discussed further below.

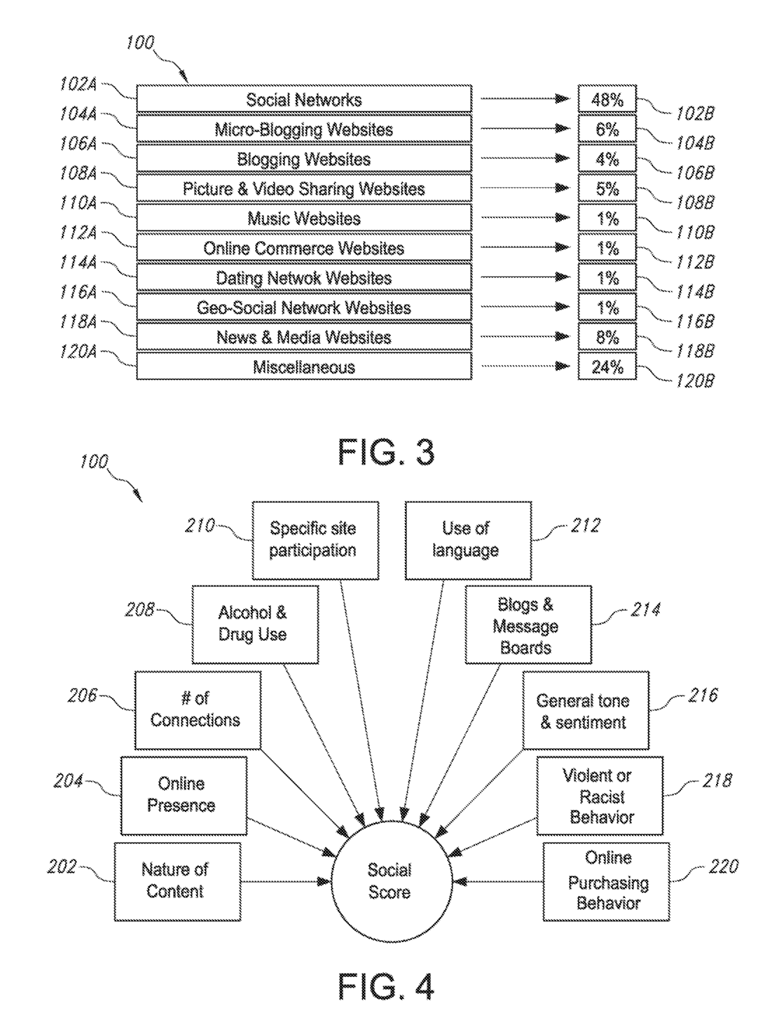

Referring now to FIG. 3 several data sources for the social scoring process are shown. One potential data source includes social networks 103a, such as Instagram™, Facebook™ Linkedln™, Meetup™ and other social networking websites. Another potential data source includes micro-blogging 105a and blogging 107a websites, such as Twitter™, StumbleUpon™ WordPress™, Tumbler™, Livejournal™, and other blogging websites. Yet another potential data source includes picture and video sharing websites 109a, such as YouTube™, Flickr™ Flixster™, and similar websites. As shown in FIG. 3 the above types of online data sources may generate a large portion of the data sourced for the analysis herein, and in these examples the above sources provide over 60% of the source data (see 103b, 105b, 107b, and 109b). Further data may be collected from music websites 111a such as Spotify™, Pandora™, Last.fm™, and iLike™; online commerce websites 113a such as eBay™, Alibaba.com™, Amazon.com™, and Epinions.com™; dating network websites 115a such as Match.com™, eHarmony™, and Tinder™; geo-social network websites 117a such as Foursquare™, Urbanspoon™, and Tripadvisor™; and news & media websites 119a such as CNN™, the New York Times™, and the L.A. Times™. Other miscellaneous websites 121a such as Mugshots.com™ Beeradvocate.com™, Hanggliding.org™ and others may also provide potential source data. The potential data sources identified in FIG. 4 are exemplary, and additional data sources may be included in the analysis.

Once raw data sources are collected for a target subject, an identity resolution engine is used to validate the subject data. Then the data is distilled into discrete data points for further analysis, based on specific factors (discussed below) determined through analysis of known data sets and validated subject content.

Turning to FIG. 4 an exemplary list of factors considered in the social score 222 is provided. The factors were determined using a sample set of 50,000 known outcomes and are capable of further refinement through use of the social scoring process based on machine learning, which allows additional factors to be developed and existing factors to be adjusted. Therefore, the risk determination process can be continually updated based on continued experience with actual data. Factors considered may include the nature of content 202, online presence 204 (or lack thereof), number of connections 206, alcohol and drug use 208, specific website participation 210, use of language 212, blogs and message boards 214, general tone and sentiment 216, violent or racist behavior 218, online purchasing behavior 220, and other factors. Each factor for which data is available regarding a target subject may impact the ultimate risk determination. The ultimate risk determination is a recommendation based on the evaluation; in embodiments focused on insurance, the evaluation is a determination as to whether a subject would be a low insurance risk and/or less likely to commit insurance fraud.

For example, for a target subject having a LinkedIn account, the number of connections is considered. Based on the initial data set of known outcomes, subjects with 200 or more LinkedIn connections are lower risk, and this is therefore factored into the social score if applicable. In further examples, a target subject exhibiting blatant violent and/or racist statements online is higher risk. In yet further examples, a target subject actively contributing to the New York Times™ or Wall Street Journal™ websites is lower risk. In additional examples, a subject demonstrating alcohol abuse or illicit drug use is higher risk. For embodiments evaluating potential insurance risk, a social score indicating a lower risk subject indicates that the subject is a lower claim risk and/or less likely to commit insurance fraud.

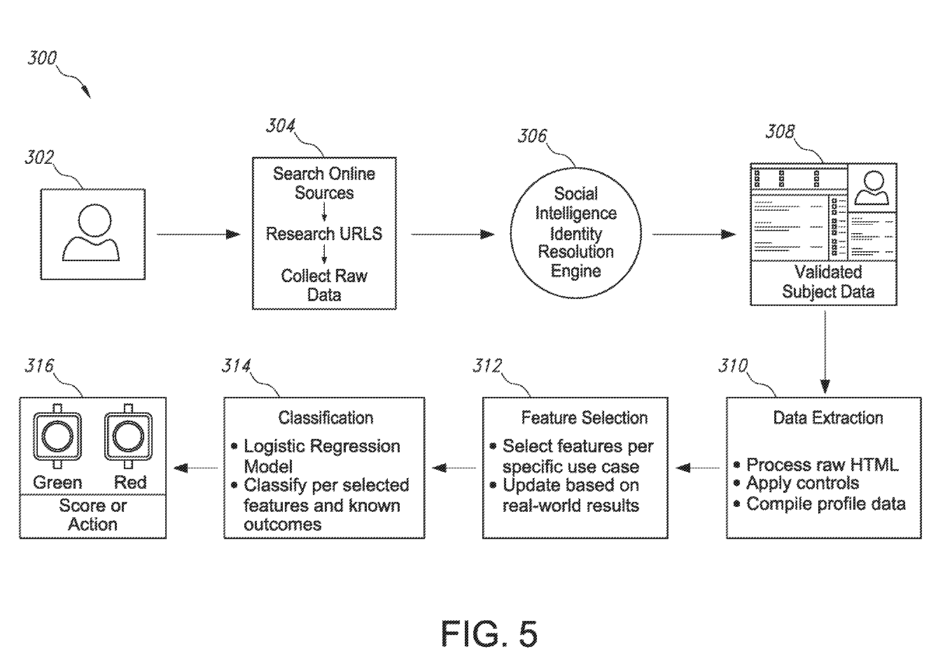

Turning to FIG. 5 a flowchart 300 detailing the process for analyzing a target subject and providing a green light report is provided. At 302, a target subject is identified. Then, at 304 publicly available online sources are searched, URL's are identified, and raw data is collected corresponding to the target subject. Next at 306, an identity resolution engine can be used to analyze the raw data and filter out data not applicable to the target subject, yielding the validated subject data at 308. For example, the identity resolution engine can include the Social Intelligence® Identity Resolution Engine.

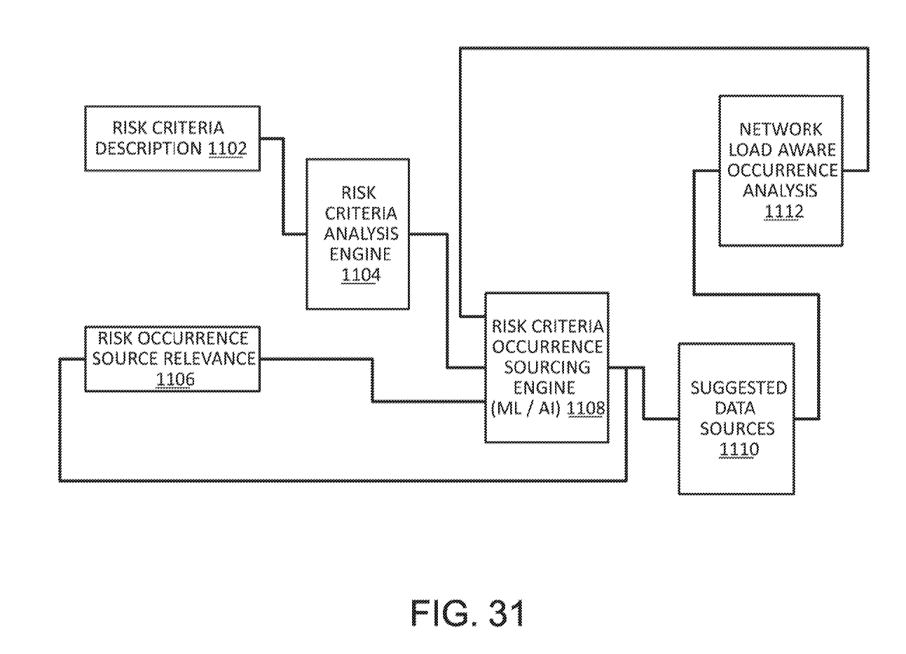

At 310, the validated subject data is processed and assembled into profile data. The validated subject data, which is in raw form, is distilled into individual components by removing extraneous content, such as HTML tags, javascript code, and other extraneous information. Next, according to some embodiments, in order to provide a consistent comparison across subjects, controls are applied to the data. Controls may be based on age, demographics, geographic region, and other factors in order to provide appropriate comparisons. As an example, a comparison of social media usage between a twenty-one (21) year A subject and a sixty (60) year A subject would be unlikely to yield an appropriate comparison, as the social media usage of the Aer subject is likely to be substantially less, and related factors, such as number of friends or connections, would likely be less as a result. Thus, controlling the data for age, in these examples, provides for a more appropriate comparison relating to social media usage and related factors. Finally, the data is assembled into structured values and stored as a profile relating to the target subject. With reference to FIGS. 31, 32, and 33, examples of a profile 914 can be delivered, summarized, edited and the like is partial screen views depicting examples of portions of a finished claims report 902 that may include the subject information 904, the loss event information 908, the social interests 910, the flagged content 912, and the like that may be reviewed, edited, and ported to and from a multitude of sources in support of the predictive social scoring process in accordance with the present disclosure.

At 312, discrete features of the subject profile are selected for further analysis. In some embodiments, the relevant features are selected based on the specific use case, such as insurance evaluation and/or quotation, employment assessment, business risk, or other use cases. According to some embodiments, a template for each specific use case is maintained, to identify the most desirable features for risk evaluation for that use case. In some embodiments, the template is adjusted based on additional data from actual outcomes.

The system 300 includes a large annotated database of data derived from known outcomes. According to some embodiments, this database is a customer contributory database that is further updated based on continuing information regarding the data set. For example, an insurer may contribute follow up information for target subjects regarding actual loss data. These additional known outcomes are stored in the database and used to further refine the predictive social scoring process.

At 314, the target subject is classified by evaluating the selected features of the subject profile in comparison with the database information based on known outcomes. For embodiments providing a binary report, such as a green light or red light risk analysis, the risk scoring classification is performed using logistic regression to predict the expected outcome based on the selected features as predictive variables. In other embodiments, where more risk scoring assessment categories are desired, a multinomial logistic regression may be used, for example, where target subjects are to be divided into low risk, medium risk, and high risk categories. Although logistic regression is provided in the preferred embodiments, it is understood that other statistical methods of predicting expected outcomes for a set of selected feature data may be utilized.

Ultimately, as shown at 316, according to some embodiments, a subject that is predicted to be a low risk is identified with a green light, and a subject that is predicted to be a high risk is identified with a red light. In other embodiments, a relative risk score is provided instead of a green or red light report. By identifying high risk subjects, according to some embodiments, an insurance company can avoid these subjects and transfer that risk to other insurers, such as their competitors. Similarly, according to other embodiments, a potential employer can avoid potential high risk employees who are more likely to expose the potential employer to human resource complaints and/or legal action. Furthermore, by identifying low risk subjects, evaluators can save time and money by avoiding more detailed reporting and/or investigation for these low risk candidates.

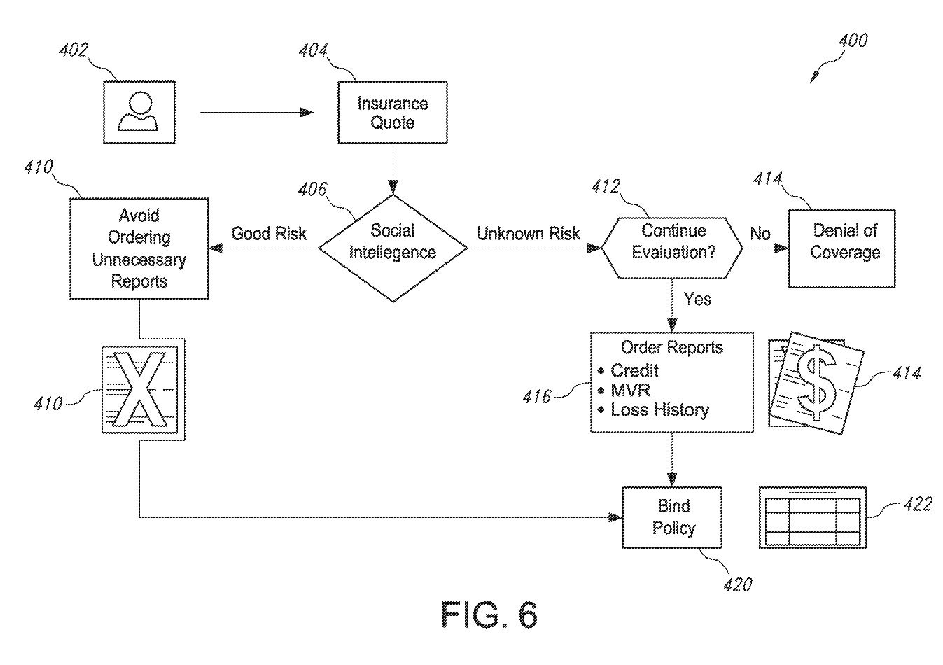

In FIG. 6, exemplary embodiments of an insurance quote process are shown. In these embodiments, the applicant is applying for auto insurance, although the process can be applied to other types of insurance, or other processes where loss prediction is beneficial. At 402, an applicant for the auto insurance policy is identified, and at 404 the insurance quote process begins. The known information regarding the applicant is provided as input to the Social Intelligence social scoring process at 406, and that process provides a recommendation (for example, as detailed in FIG. 4). If the recommendation is a good risk (or “green light”) the quote process proceeds to 408, where the process determines that no additional investigative reports are required (illustrated by 410). Therefore, the process continues to 420, where the policy is bound (illustrated by 422). Thus, for applicants identified as low risk, immediate cost savings are provided through the avoidance of extensive 3^{rd} party reports, by leveraging the world's largest contributory-database web-based social media.

On the other hand, going back to 406, if the recommendation is an unknown risk (or “red light”) the quote process proceeds to 412. At 412, the potential insurer can decide whether to continue the evaluation of the applicant through further investigation or opt to end the application process by denying coverage. If the evaluation is concluded with a denial of coverage 414, the potential insurer benefits by shifting the risk associated with this applicant away from them and to another insurer. Alternatively, the evaluation can continue by investigating additional data associated with the applicant.

At 416, the potential insurer will want to purchase additional information regarding the applicant (illustrated by 418), such as a credit report, motor vehicle report, loss history report, and/or other supplemental information in order to make a determination as to whether to insure the applicant. After evaluating the additional information, the insurer can then elect to insure the applicant and bind the policy at 420.

Alternatively, the recommendation of the social scoring process at 406 can be provided as a numeric range or other scales of relative risk scores, instead of a green light/red light report. Additionally, the application process can utilize the relative risk score to determine whether to accept the application and/or perform a further investigation, and/or at what price point the application should be granted. For example, in some embodiments, alternative payment plans result based on different relative risk scores. Furthermore, in embodiments related to loan applications, a poor risk prediction score can lead to a denial of the lending instrument.

Thus, the predictive social scoring process as set forth herein can identify potential low risk candidates, and allow a party assessing risk to avoid potential claims, reduce moral hazards, and/or shift the potential risk to their competitors by avoiding high risk applicants. Alternatively, the choice can be made to accept high risk applicants at an adjusted cost, such as, in the insurance context, higher premiums for high risk subjects. For example, in alternative embodiments, applicants reaching 420 through additional investigation and reports 416 might be required to pay an increased application fee, in comparison to an applicant that reached 420 via 408. In still other embodiments, applicants that are identified as higher risk may be charged higher premiums.

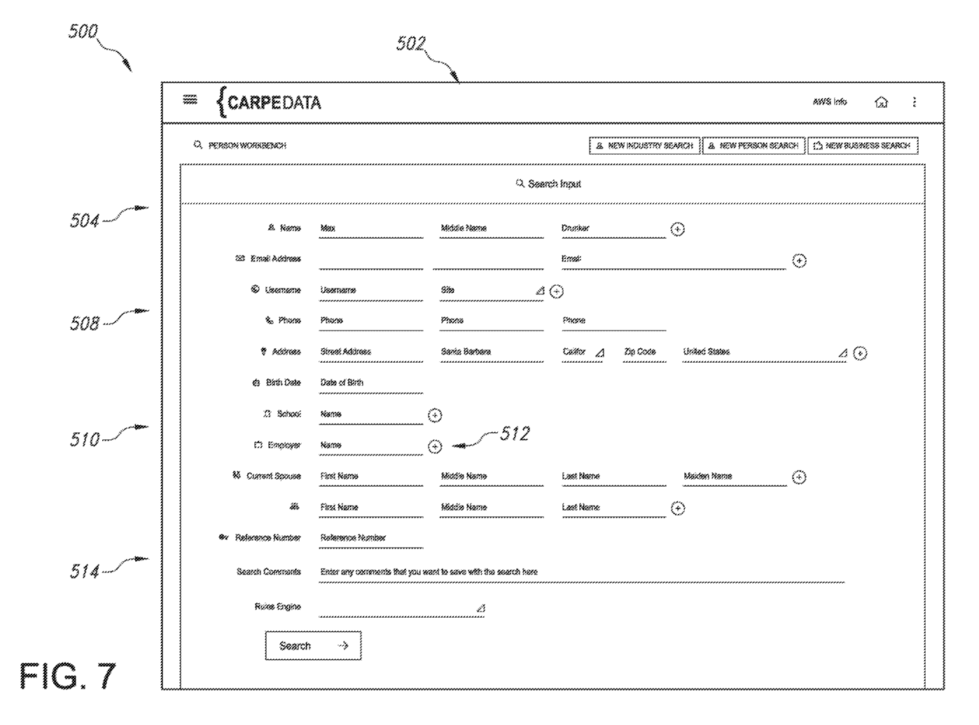

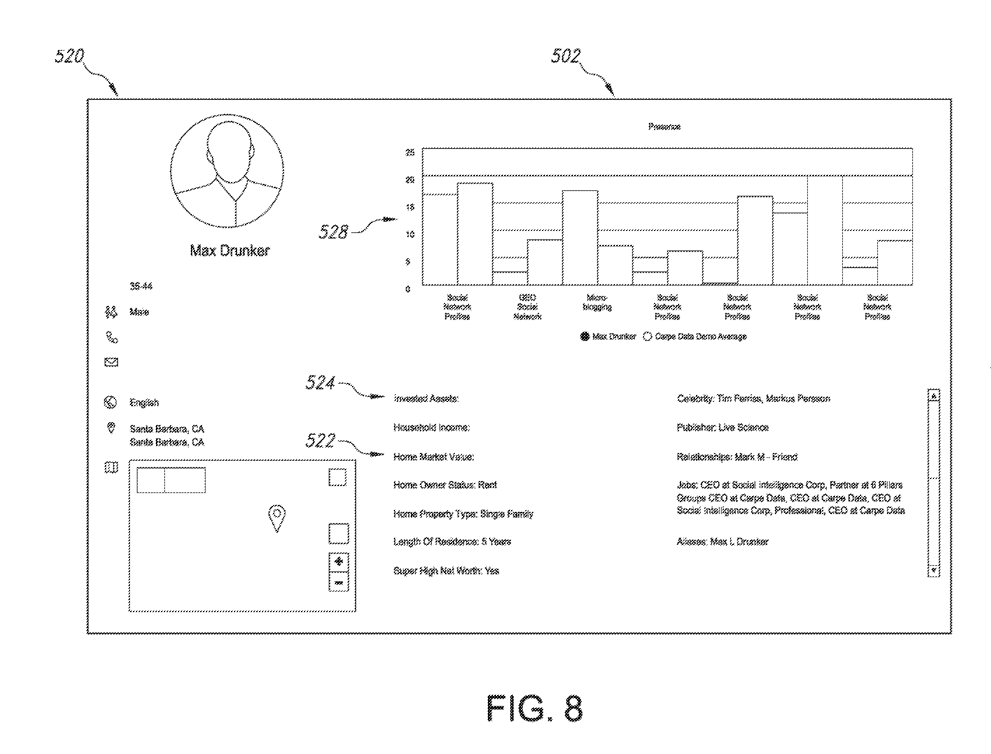

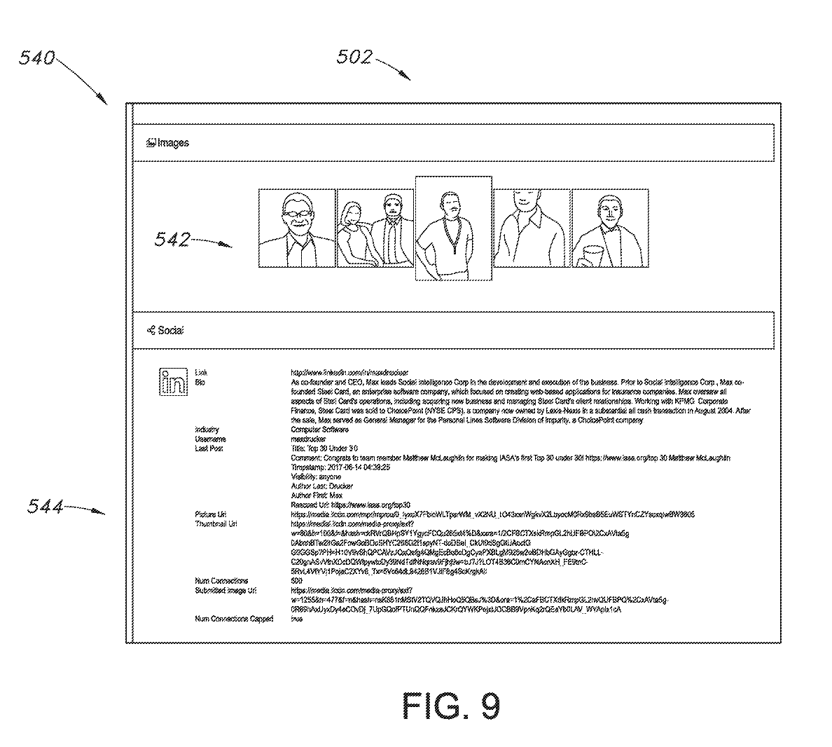

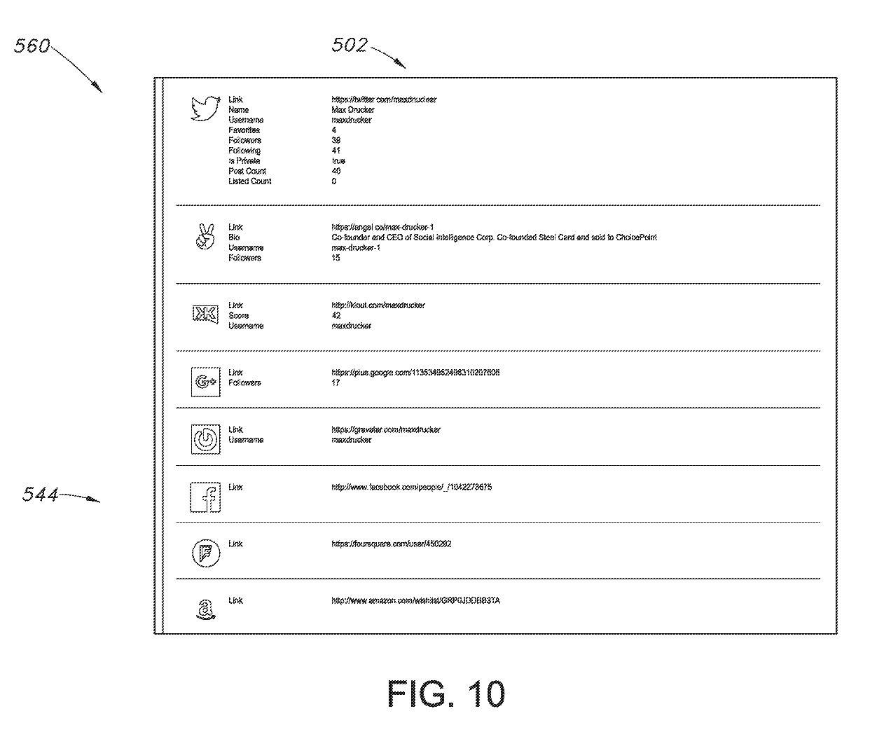

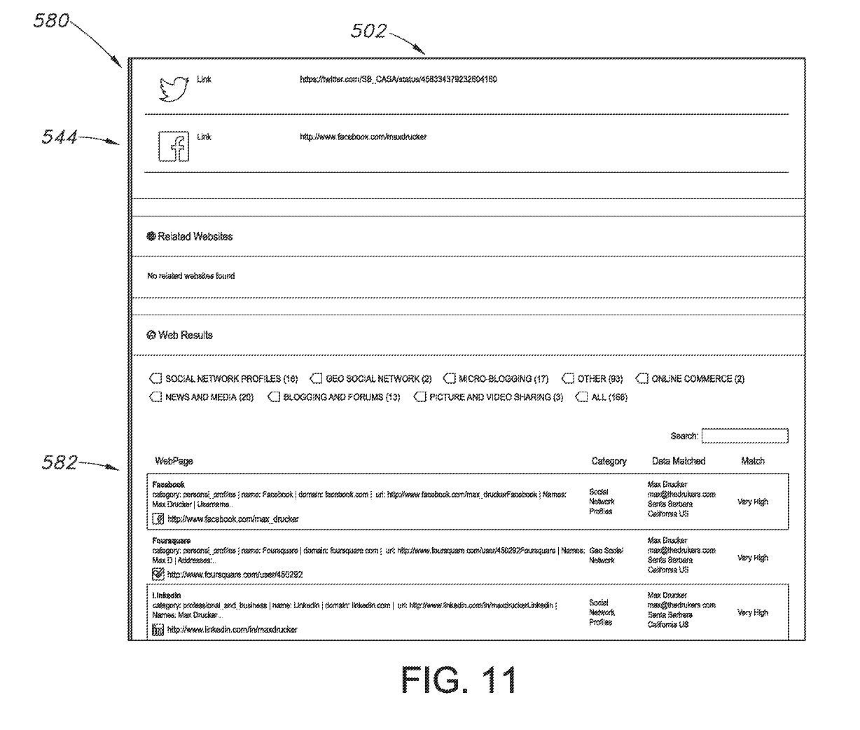

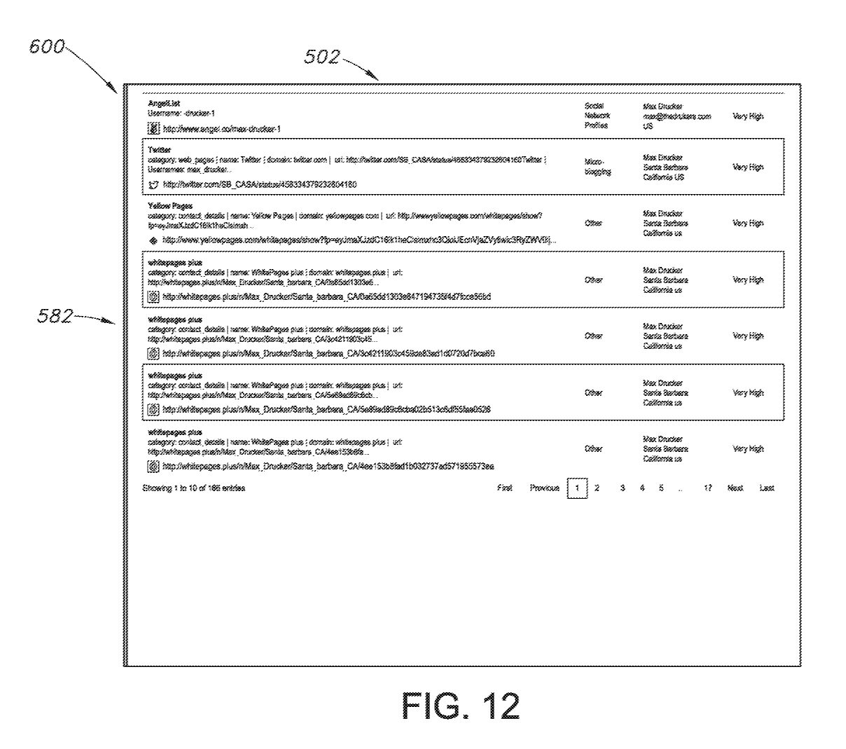

With reference to FIG. 7, a partial screen view 500 depicts examples of a portion of a person workbench 502 showing information including name information 504, residential address information 508, school information 510, employer 512, spouse 514 and the like that may be inserted and/or obtained from a multitude of sources in support of the predictive social scoring process. FIG. 8 depicts a partial screen view 520 depicting examples of a portion of the person workbench 502 showing information including home value and information 522, net worth 524, online presence information 528 and the like that may be inserted and/or obtained from a multitude of sources in support of the predictive social scoring process. FIGS. 9, 10, 11, and 12 depict partial screen views 540, 560. 580, and 600 depicting examples of portions of the person workbench 502 showing information including relevant images 542, social media information 544, relevant web results 582 and the like that may be inserted and/or obtained from a multitude of sources in support of the predictive social scoring process.

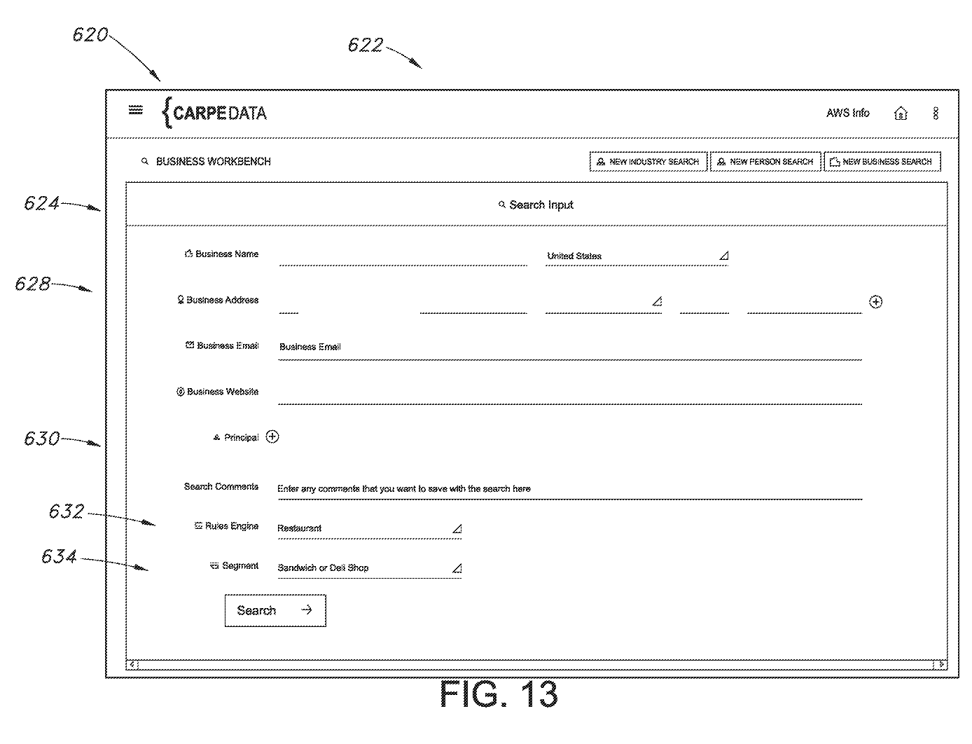

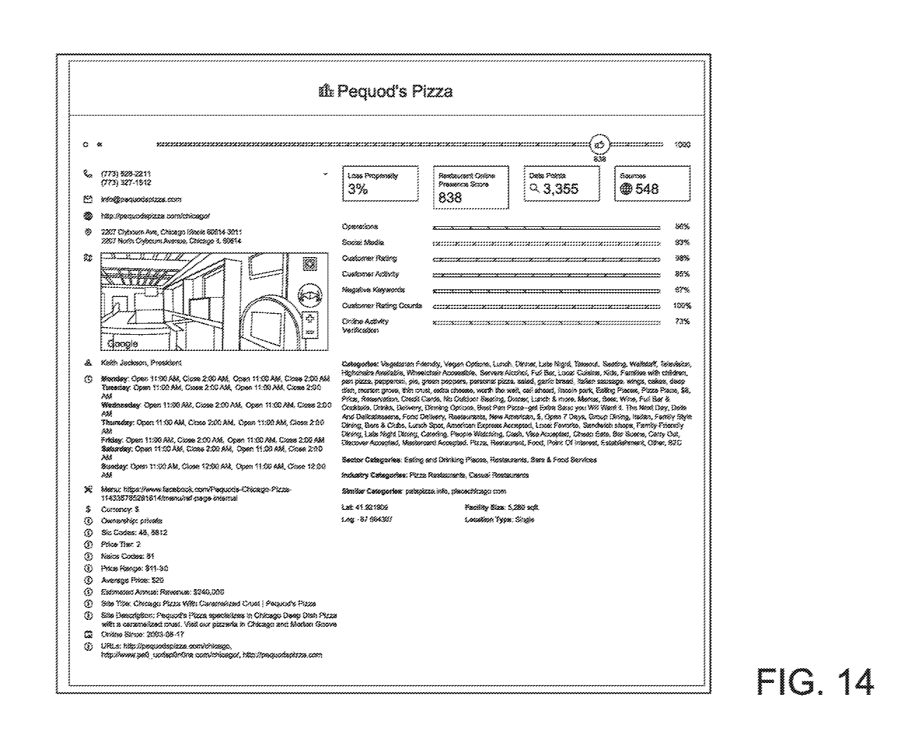

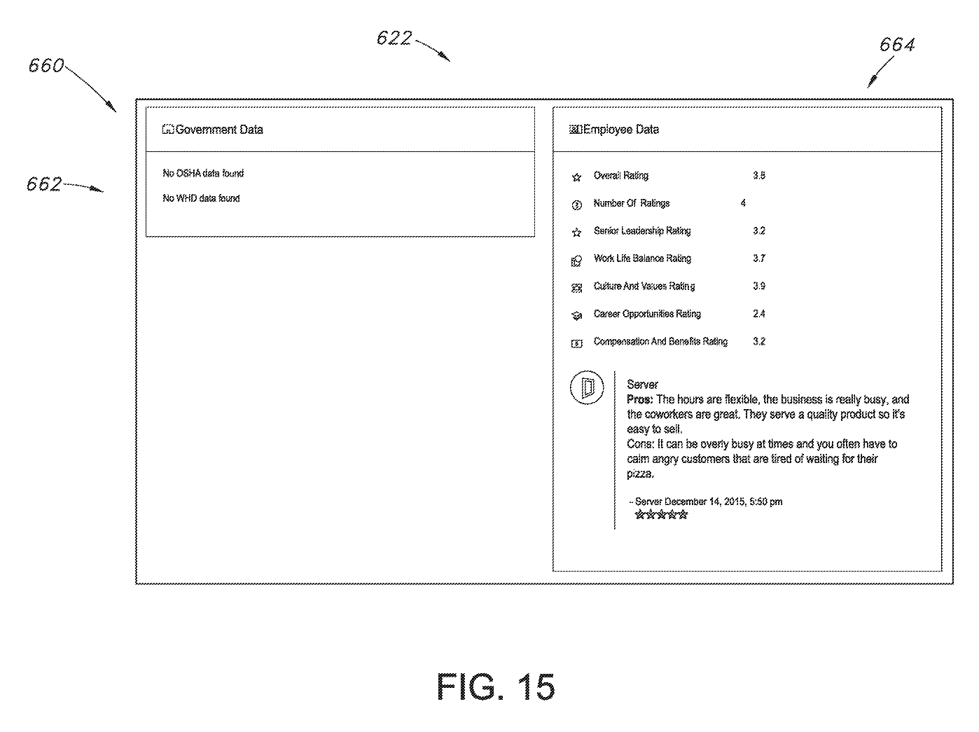

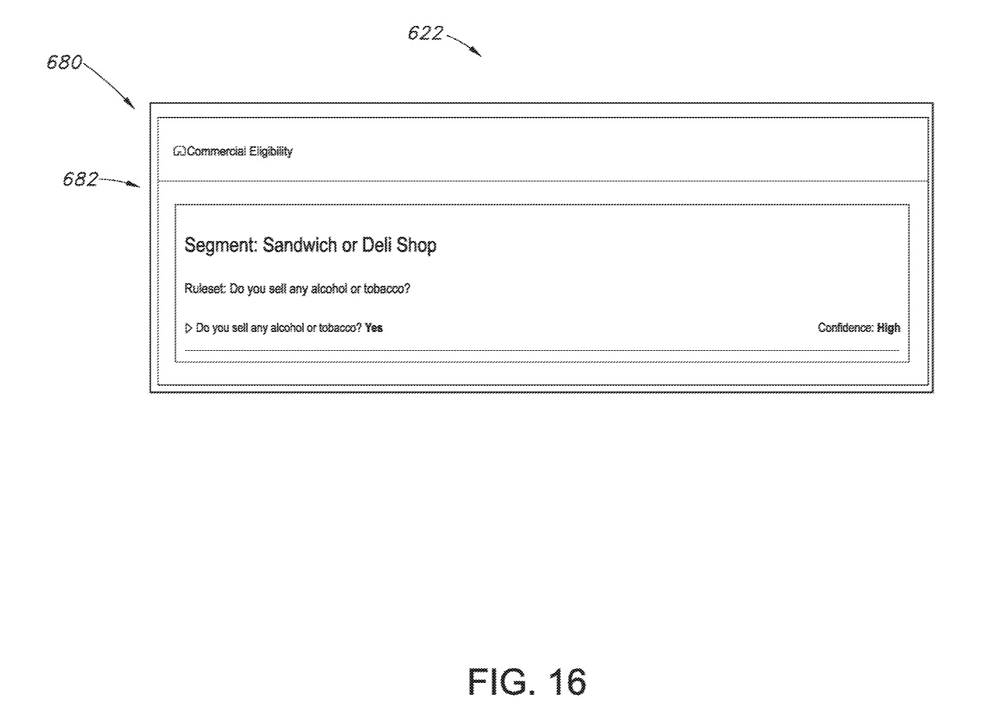

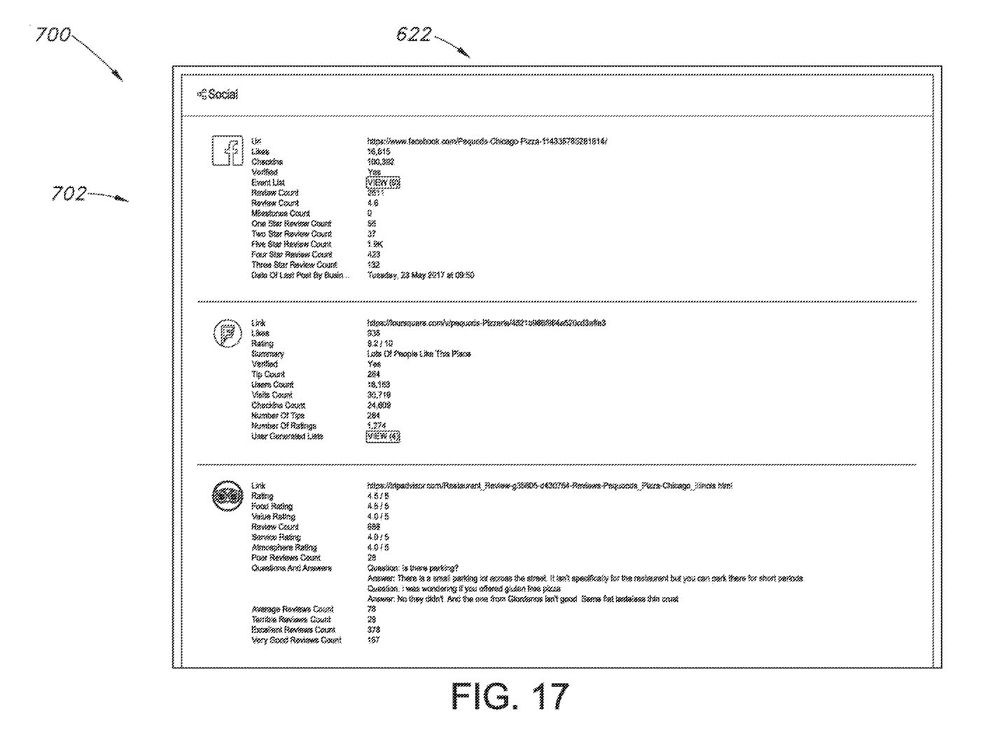

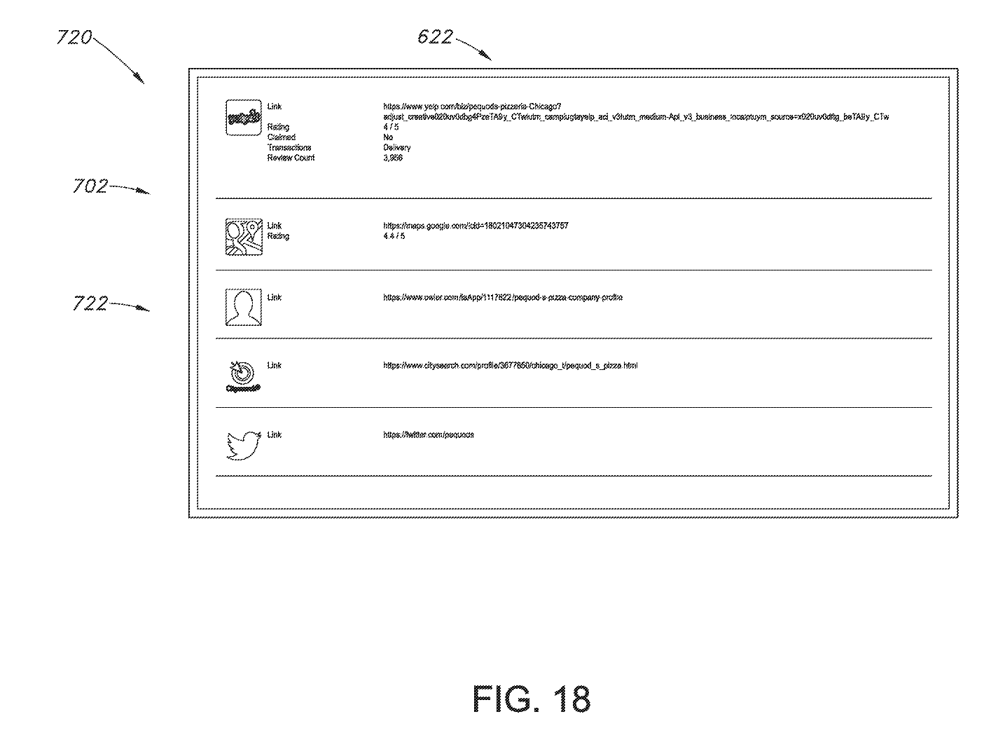

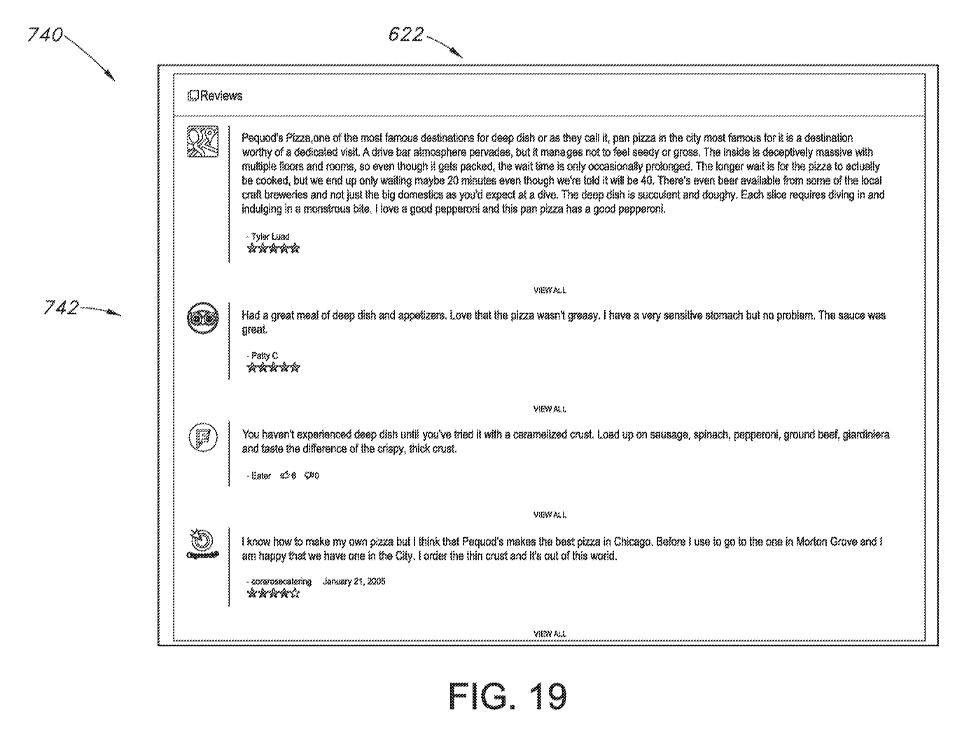

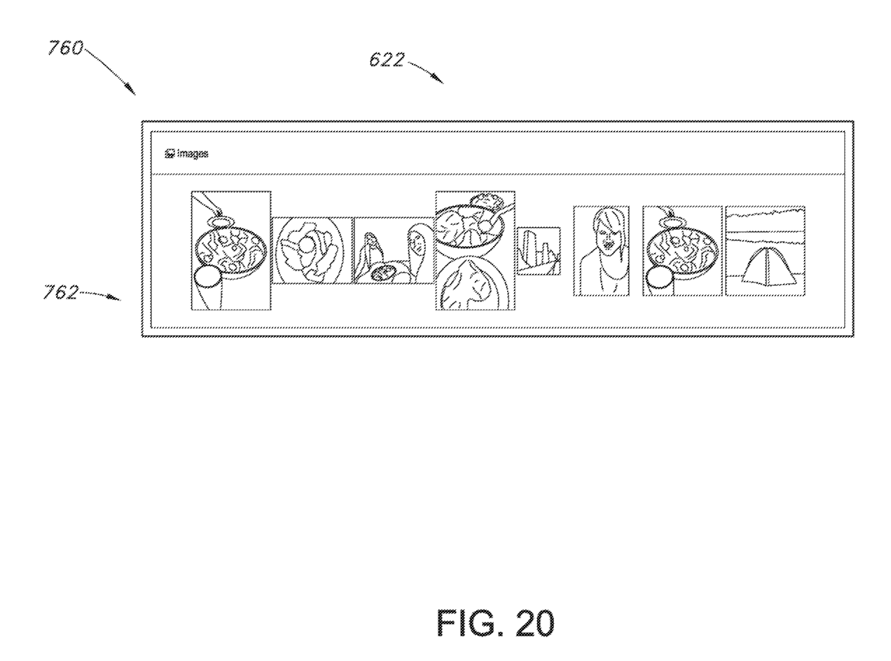

FIG. 13 depicts a partial screen view 620 depicting examples of a portion of a business workbench 622 showing information including business name 624, business address information 628, corporate structure information 630, rules engine information 632, segments information 634, and the like that may be inserted and/or obtained from a multitude of sources in support of the predictive social scoring process. FIG. 14 is a partial screen view 640 depicting examples of a portion of the business workbench 622 showing information including business hours 642, business metrics 644, a loss propensity score 648, a business online presence score 650, an amount of data points considered 652, a number of sources from which the information displayed was found 654, and the like in support of the predictive social scoring process. FIG. 15 is a partial screen view 660 depicting examples of a portion of the business workbench 622 showing information including government database information 662, employee and employment information of the business 664, and the like that may be inserted and/or obtained from a multitude of sources in support of the predictive social scoring process. FIG. 16 is a partial screen view 680 depicting examples of a portion of the business workbench 622 showing information including commercial eligibility for serving alcohol or tobacco 682 and the like that may be inserted and/or obtained from a multitude of sources in support of the predictive social scoring process. FIGS. 17, 18, 19, and 20 are partial screen views 700, 720, 740, and 760 depicting examples of portions of the business workbench 622 showing information including social media information 702, website information 722, reviewer information and content 742, relevant images 762 and the like that may be inserted and/or obtained from a multitude of sources in support of the predictive social scoring process.

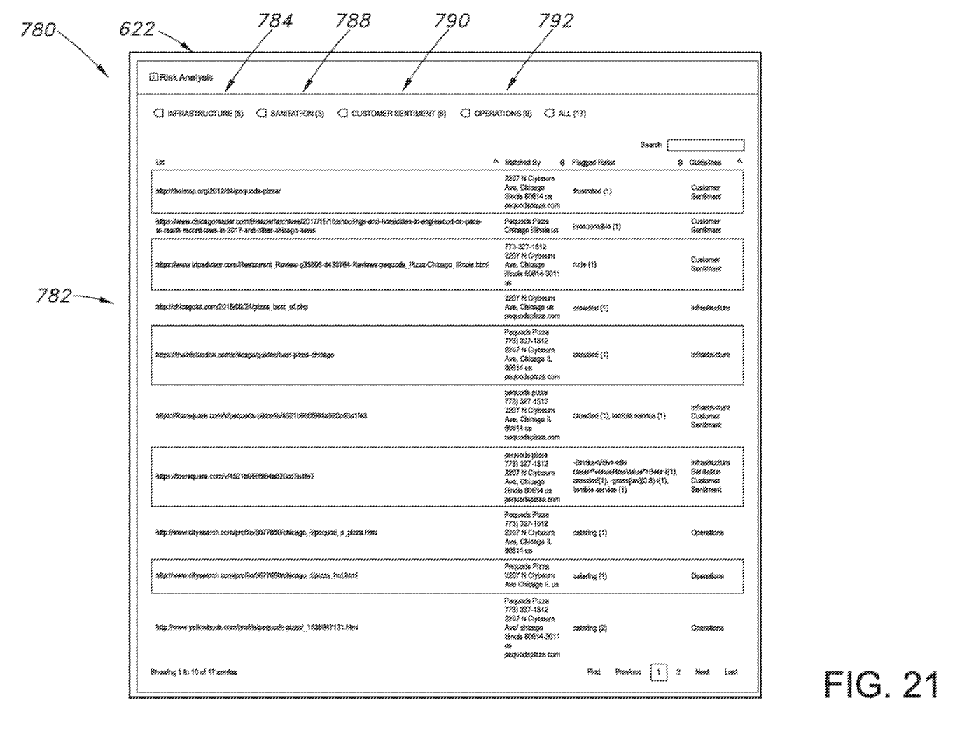

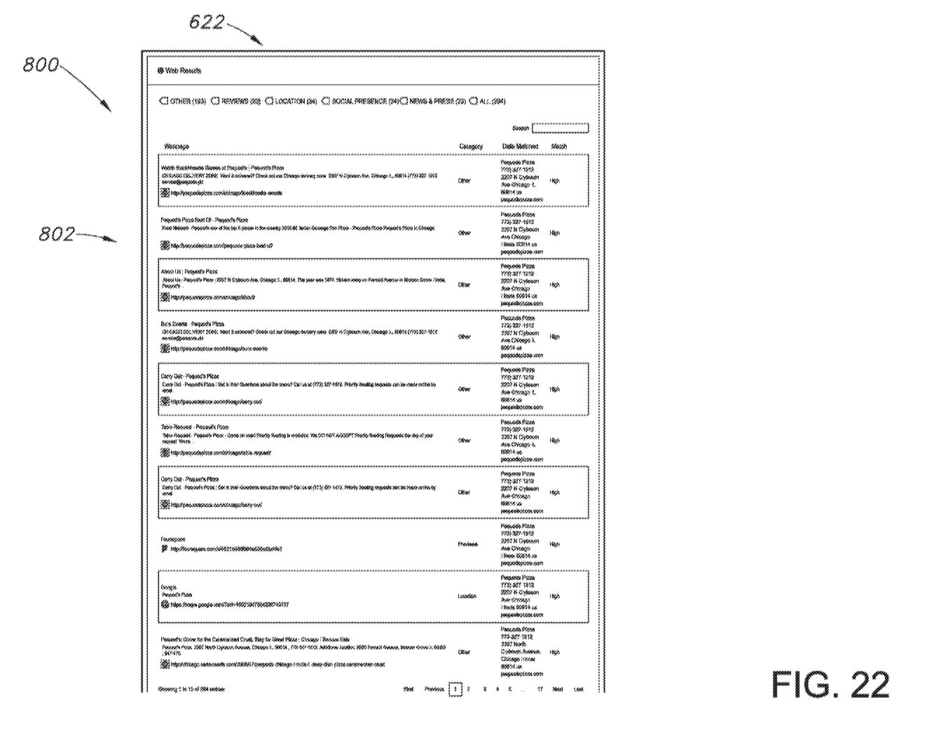

FIG. 21 is a partial screen view 780 depicting examples of a portion of the business workbench 622 showing information including risk analysis information 782 that includes infrastructure content 784, sanitation content 788, customer sentiment content 790, operations contents 792 and the like that relate to a business that may be inserted and/or obtained from a multitude of sources in support of the predictive social scoring process. FIG. 22 is a partial screen view 800 depicting examples of a portion of the business workbench 622 showing information including web results 802 that relate to the business that may be inserted and/or obtained from a multitude of sources in support of the predictive social scoring process.

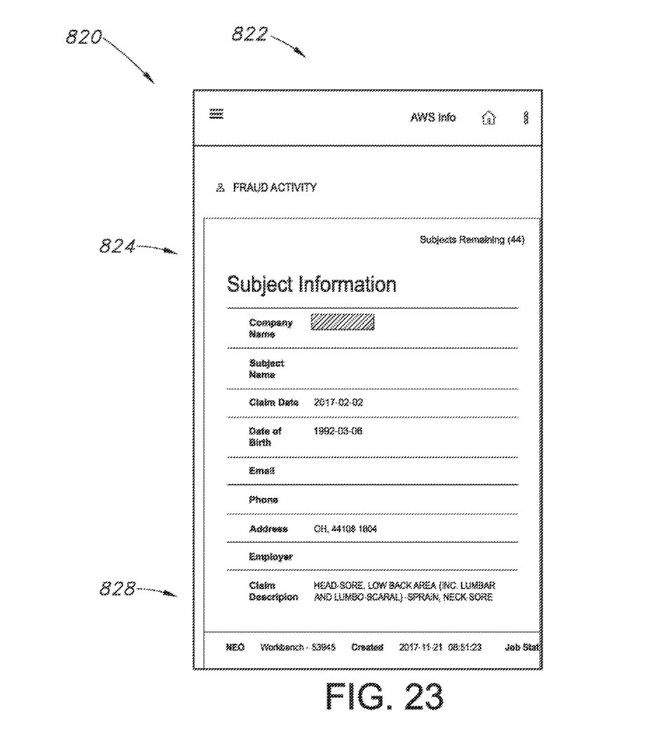

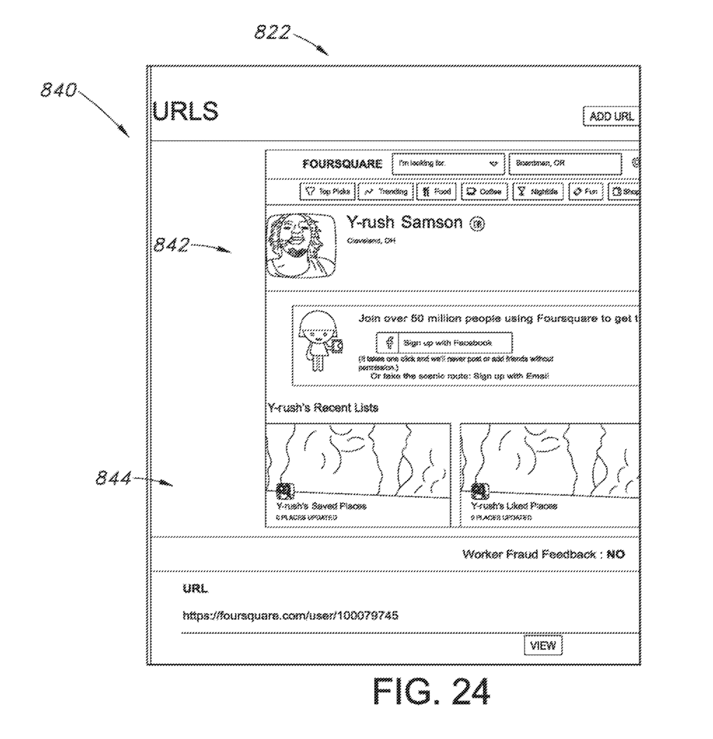

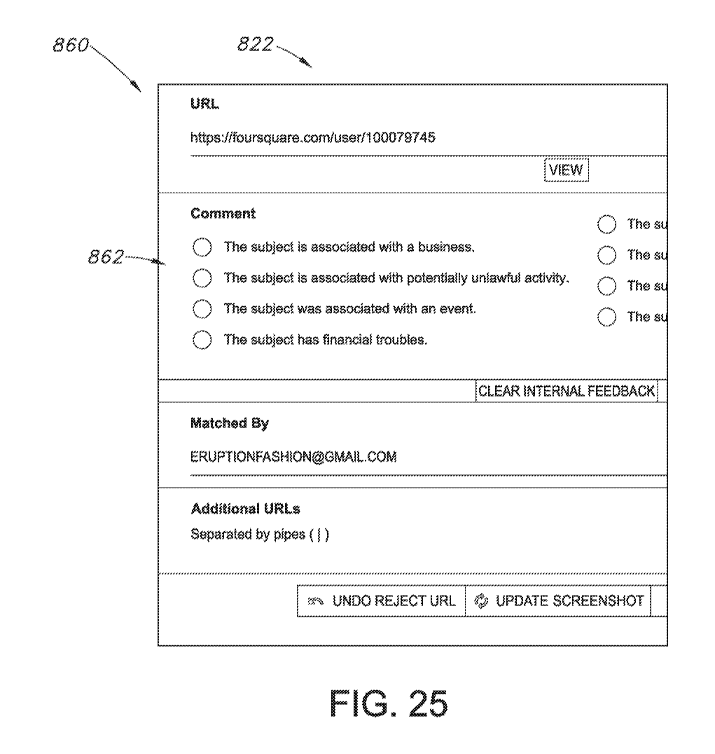

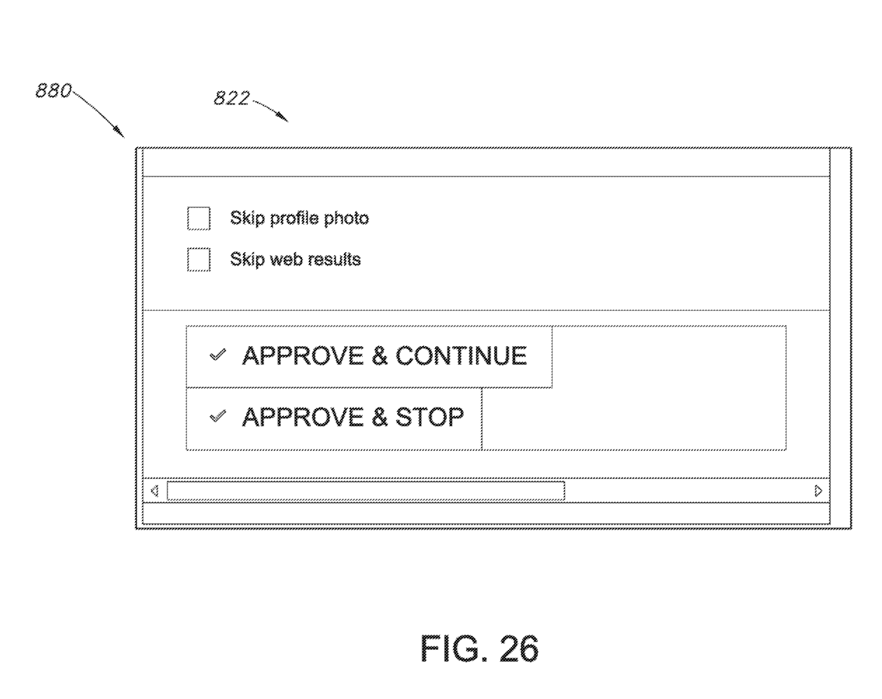

FIGS. 23, 24, 25, and 26 are partial screen views 820, 840, 860, and 880 depicting examples of portions of an internal analyst claims workflow 822 showing information including subject information 824, claim description 828, relevant images 842, social media information 844, possible fraud indications 862, and the like that may be inserted and/or obtained from a multitude of sources in support of the predictive social scoring process.

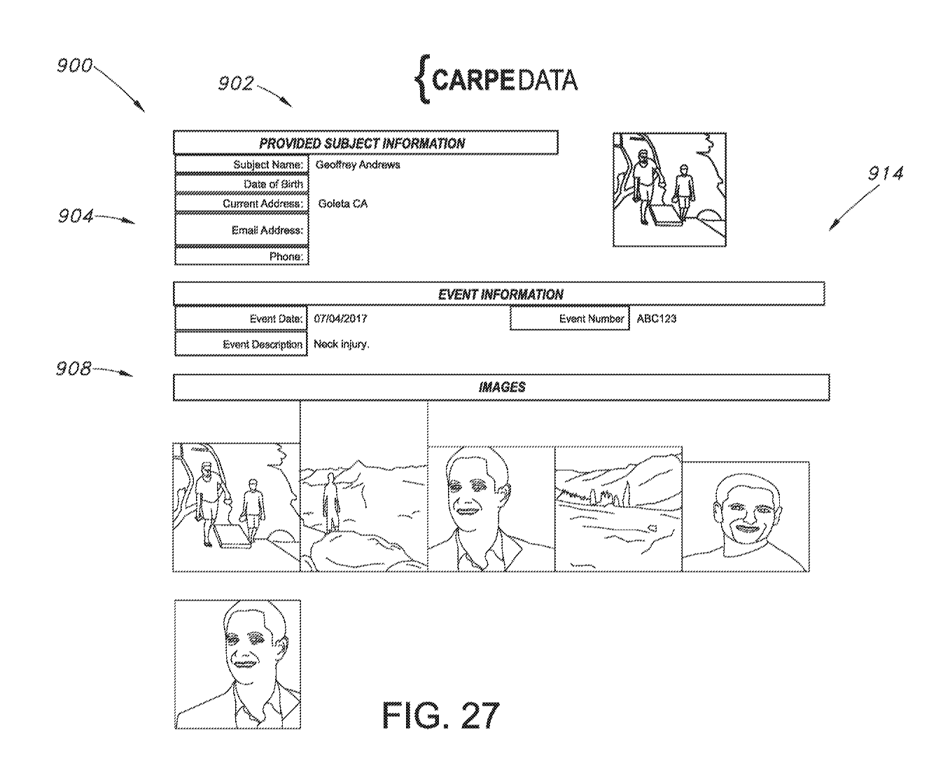

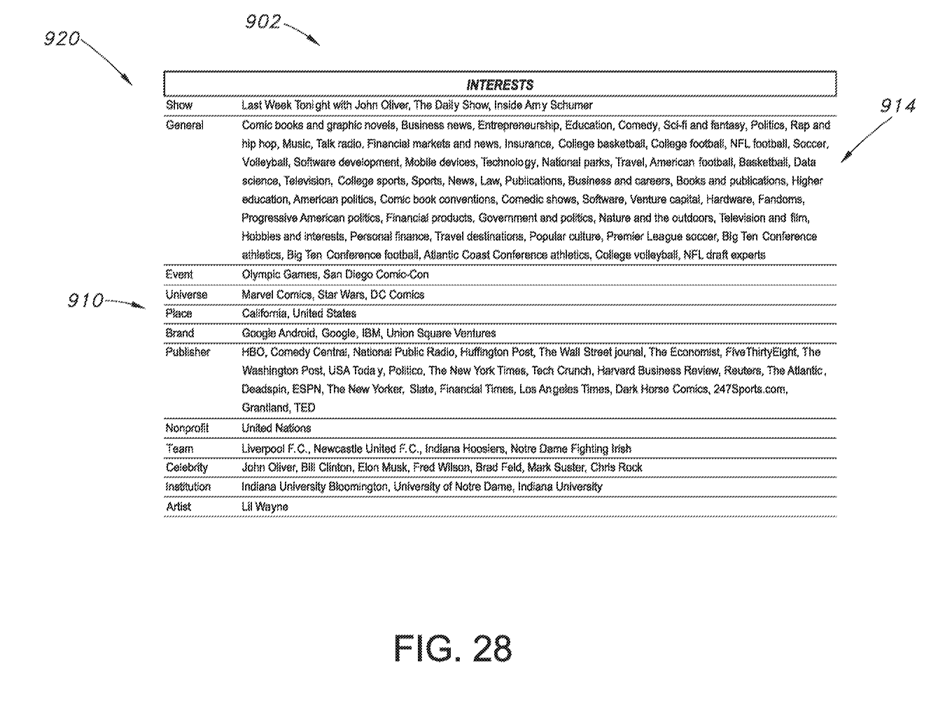

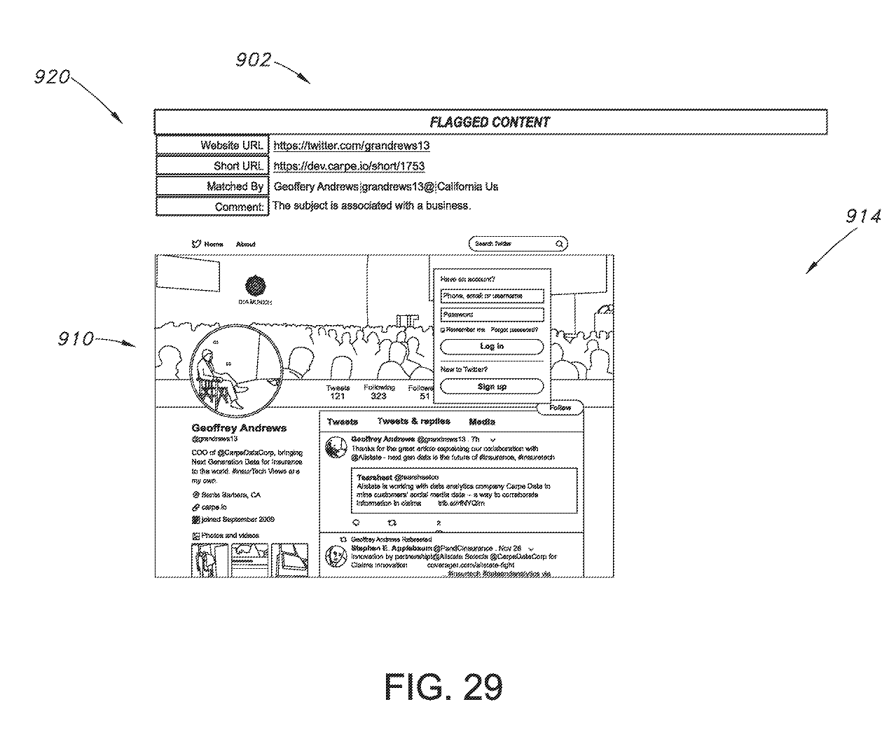

FIGS. 27, 28, and 29 are partial screen views 900, 920, and 940 depicting examples of portions of finished claims report 902 showing information including subject information 904, loss event information 908, social interests 910, flagged content 912, and the like that may be reviewed from a multitude of sources in support of the predictive social scoring process. In many examples, the profile 914 can be delivered, summarized, edited and the like in the various partial screen views depicting examples of portions of a finished claims report 902. These portions of the finished claims report 902 may include the subject information 904, the loss event information 908, the social interests 910, the flagged content 912, and the like that may be reviewed, edited, and ported to and from a multitude of sources in support of the predictive social scoring process.

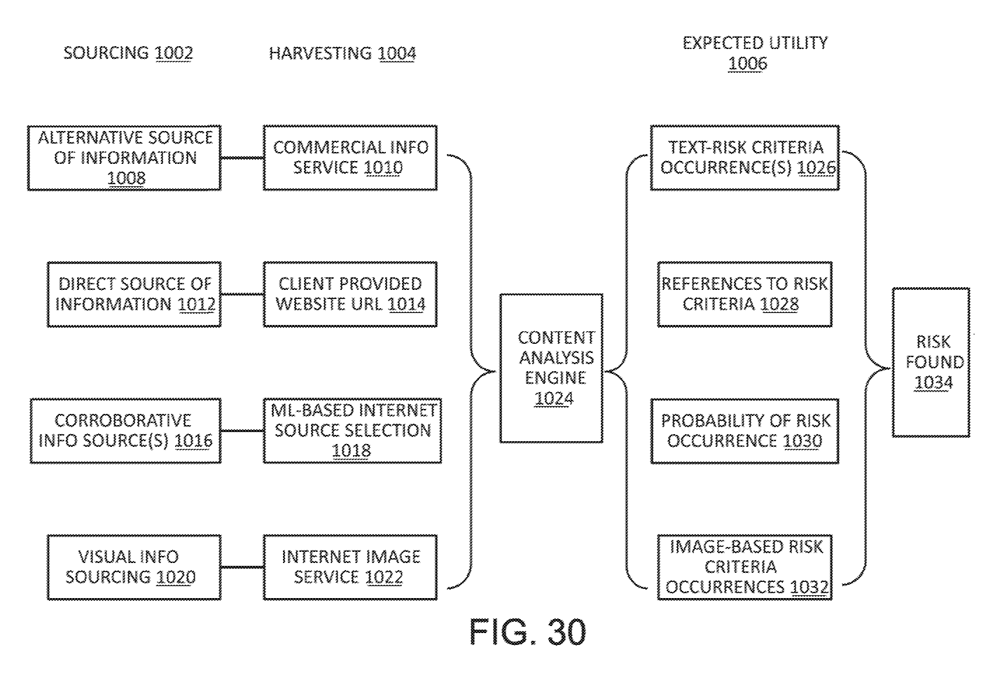

Referring to FIG. 30, a block diagram in which a multi-disciplinary approach to data analysis for determining presence of a potential risk associated with risk criteria, a plurality of types of sources, harvesting techniques, and expected utility thereof are presented. As described elsewhere herein data may be sourced from a wide range of sources and may include a wide range of types of data that may exhibit substantive differences in format, structure, content, quality, values and the like. Gathering data from these sources may require a plurality of harvesting approaches as well as a plurality of content interpretation approaches. In an example, harvesting content from an image library may be configured with a desired outcome to achieve (such as by machine learning) the same objective as harvesting text content from a database (e.g., determining evidence of risk criteria occurrence(s)), or vice versa; however, the approach to each of these sources may benefit from content aware approaches. Similarly, a client may provide a direct link to a website that is descriptive of an object to be insured (e.g., a motel), whereas existing information services (e.g., YELP™ and the like) may also provide indirect access to the website while providing relevant context. Tools for accessing, harvesting, and extracting information from these sources may benefit from use of relevant platform functions. Several examples that are depicted in the embodiments of FIG. 30 are now described.

In embodiments, sourcing of information 1002 may include alternative sources of information 1008, direct sources of information 1012, corroborative information sources 1016, visual information sources 1020 and the like. In embodiments, the alternative sources of information 1008 about a target of a business product or service (e.g., an insurance product or service) may be available, such as to the public and/or through third parties that may control access based on a relationship with the requester. As an example, some information may be available to guest users of a commercial information service 1010, whereas other, perhaps more detailed information may be available to subscribers or identified members of the information service. Therefore, rich details about a target client may be readily harvested using controlled information access services, such as YELP™, yellow pages, business information services, industry-specific information services and the like. Such a commercial information service 1010 may facilitate structured access to relevant information from a target client's website, by, for example, providing a uniform presentation of web site content across a wide range of websites. This may allow a content harvesting engine to access specific types of information from a website without having to know the format or content flow in the website. The commercial information service 1010 has already allocated information from the website to a range of types of information (e.g., has structured the content into type-specific elements). As an example, YELP may present information about a restaurant consistently independent of the underlying website from which the information is gathered, such as location, cost range, menu, size, and the like. Having access to this pre-structured information may facilitate validation of unstructured data sources for the target client and the like.

As mentioned above, some of this information may be available to guest users of the commercial information service 1010. However, automated access to more in-depth information about a target client (e.g., a requester of insurance cover and the like) may be automatically achieved through preconfigured membership in the commercial information service, such as by subscribing to receive member login credentials and the like. In embodiments, other computer-to-computer communication functions may be used, such as Application Programming Interfaces and the like that may be provide authenticated access to the in-depth content on-demand. Once harvested, this pre-structured information may still contain unstructured content (e.g., may be textual description of an aspect of an object for which insurance protection is requested and the like). Therefore, further analysis by techniques such as Natural Language Processing (NLP), machine learning and the like may be applied as described herein to facilitate a risk criteria-based understanding of the content.

Continuing with the embodiments of FIG. 30, the platform may utilize the direct sources of information 1012, such as an application for insurance, a link to a profile, and the like. In an example, a direct source of information may be accessed through a link 1014, such as a link to a website, which may include descriptions or representations of the asset for which the business services are being requested (e.g., a set of web pages that describe physical, financial, and other aspects of an asset, such as a piece of real estate and the like). The direct source of information may be identified, such as through accessing a client's website or the like. Validation of the direct source of information, as compared to validation of the content therein, may be performed through third-party website and the like including ownership registration services, government records (e.g., real-estate transaction data) and the like. The content of such direct sources of information may be processed with the techniques described herein, such as NLP, keyword/phrase identification, risk criteria occurrence counting (e.g., via machine and/or human analysis of text, images, and the like) to facilitate determining a contribution of the direct source of information to a risk assessment, indicator or index as described herein. Over time, validation of direct sources may also be evaluated, such as to determine what direct sources are typically most valid. For example, sites that include regular user feedback (such as Yelp) may be found, by tracking validation results, to more frequently have accurate information, as a result of the feedback process, than sites that do not receive such feedback (such that inaccurate information is more likely to persist).

Further in reference to FIG. 30, a wide range of additional corroborative information sources 1016, typically accessible by a computer through the Internet and the like, may be available for, among other things, corroborating the alternative sources of information 1008 and the direct sources of information 1012. This information, while not directly provided by the client and/or not curated and structured by a third party such as YELP™ and the like, can be a rich source of corroborative and validating content. However, determining which sources of such information are worth pursuing, effectively utilizing the resources of the platform and others to identify, harvest, and vet the information, is a substantive opportunity for efficiency while maintaining a high degree of confidence in a resulting risk indicator. Therefore, source selection techniques 1018 that are described elsewhere herein, including techniques that may target consuming lower network bandwidth, less computing resources, and the like may be applied to select a subset of all possible and optionally a subset of relevant source of information. Such information may be targeted for harvesting when, for example, a confidence in the information gathered from, for example, direct corroborative information sources 1016 and the alternative sources of information 1008, is below a confidence threshold. This may occur in embodiments when a number of occurrences of a risk criteria keyword/phrase is low but non-zero, or when occurrences of such keyword/phrase appears in some sources but not in others in which the occurrences is expected to occur, which may generate or represent a degree of ambiguity that could benefit from resolution (e.g., a listing on YELP includes a photograph or a text description of a swimming pool, yet an aerial photograph of a subject property does not, and the like). In addition to computer learning and other solutions, in embodiments, crowd sourcing resources may be employed to facilitate corroboration thereof. Such crowd source techniques are described elsewhere herein.

Yet in further embodiments depicted in FIG. 30, methods and systems of determining relevance of information for use in establishing a risk indication and the like for, among other things offering of a business service, such as an insurance service or product, may include utilizing visual information sources 1020 and the like. Visual information sources 1020 may include digital visual information, such as photographs of an asset, images of documents, digital copies of identifying information, such as finger prints, facial images, and the like may be accessed over networks, such as through an Internet image source services 1022, such as social media, digital photograph archiving services, Internet archiving services, and the like. Various image processing and analysis techniques, some of which are described herein and others that are known in the industry of image analysis may be applied to visual information sources with the objective of generating at least one quantified value that can be used by algorithms that determine, among other things, risk indicators and the like related to a business product or service offering. While visual information may include ranges of elements, only a portion of those elements may be relevant to a risk indication calculation and further only a quantified value derived from those relevant elements may be desired. By applying visual information image source services 1022, such as services that facilitate searching image databases and the like via attributes, which may be described by keywords and the like, images that have some relevance to risk criteria, for example, may be provided for further harvesting and analysis. In an example, an insurance claim for damage to a vehicle may include a text reference to headlight damage. The insurance claim may include, or may reference, images of the vehicle for which coverage is requested. By utilizing the image source services 1022 that facilitates locating relevant images, a keyword, such as headlight or the like, may be provided by the platform to such a service to facilitate extracting one or more images of the vehicle that include a headlight, or a front of a vehicle where a headlight would be disposed, and the like. The image source services 1022, may be incorporated into or with a platform 100 as described herein or may alternatively or in addition be accessed as third-party services that the platform utilizes in an on-demand or similar approach.

In embodiments, contributions toward an outcome, such as a risk indicator and the like of information sources may include quantification of text-based risk criteria occurrence data 1026, references to risk criteria 1028 or other directly indicated information of an asset, probability or confidence indicator 1030 of occurrences in the sources of data of the risk-related criteria, and quantified image-based risk criteria occurrence 1032. In embodiments, the information sources can be alternative sources of information 1008, direct sources of information 1012, select corroborative information sources 1016, visual information sources 1020 and the like. In embodiments, the quantification of text-based risk criteria occurrence data 1026 can be a presence or an absence, counts, density, frequency, distribution, and the like. In embodiments, the directly indicated information can be a legal document, statement of ownership and the like of an asset. In embodiments, the probability or confidence indicator 1030 of occurrences in the sources of data of the risk-related criteria include, for example, how well corroborated is information found in one or more other sources, and the like. These expected contributions or utility of information sources may be numeric or other quantified value that may be combined algorithmically to establish a measure of a risk criteria being found 1034. As an example, a count of occurrences of keywords in the text-based risk criteria occurrence data 1026 related to a business product or service offering (e.g., keywords that relate to a potential for an insurance risk) may be combined with a count or other measure of references to the risk criteria 1028. The combination of the text-based risk criteria occurrence data 1026 the risk criteria 1028 may be further combined with a result of the analysis of the image-based risk criteria occurrence 1032 and further modified (e.g., weighted) by a probability of risk occurrence to provide a value or range of values that a risk or other factor that may impact a business service offering and the like present in the real world.

In embodiments, descriptions, typically in text form, of a business product or service, sometimes including conditions for offering the product or service (e.g., an insurance product or service, and the like) may include a range of terms that relate the offering to real world situations, environments, structures, practices, and the like. These descriptions may include references to certain real world elements and/or situations that may impact the business offering. In example, an insurance business product may list a set of factors that may impact a cost of a product or service, an approval for the use of the product or service, terms for continued use and the like. These terms may represent physical elements, such as a swimming pool, a dog, and the like; however, they may also represent conditions, such as a person's demonstrated ability to drive a vehicle, participate in work activities, physical safety and security procedures, and the like. The methods and systems described herein that relate to, among other things, establishing a degree of presence of a risk factor in the real world associated with a business product or service offer may rely on these descriptions to determine, automatically in some cases, sources of information, such as Internet-based content, to access for evidence of such risks. However, performing an Internet crawl of all possible sources of information will be costly and impact far more Internet resources (e.g., web hosting servers and the like) than needed to confirm presence or absence of the evidence of the risk. Therefore, a smart approach to identifying potential, relevant, even highly relevant sources of information is provided, embodiments of which are depicted in FIG. 31.

In embodiments, referring to FIG. 31, a risk criteria description 1102 may be captured from a description of a product or service offering, such as an insurance product. This description may be processed by a risk criteria analysis engine 1104 that may identify keywords in the description and correlate them to real-world elements that may be detected in sources of data (e.g., found over the Internet and the like). Techniques like NLP to determine term frequency and importance and the like, as well as machine learning therefore, may be applied among other approaches to correlate terms and other detectable elements in digital content that represents real world elements that may indicate a presence of a risk criteria. In an example, a service offering for lawn mowing may include a minimum amount of mowable lawn to qualify for the service. The risk criteria analysis engine 1104 may take such a description and produce a set of real world terms that may be useful for determining which sources of data to suggest. For image sources, terms such as the dimension (e.g., area) of a property, a color term (e.g., “green” for color images) may be generated, location criteria to avoid densely populated areas such as inner cities and the like may be produced. For text sources, simple terms such as lawn, or qualifiers such as expansive, field, and the like may be derived. These terms may be fed into a risk criteria occurrence sourcing engine 1108 that may employ machine learning, artificial intelligence, and other feedback-based improvement approaches to process the output of the risk criteria analysis engine 1104 and data from a data set that may include information on risk occurrence source relevance 1106 (that may include results of prior uses of the methods and systems described herein as well as third-party generated, such as human provided information), such as if a source of information pertains to a type of business product or service offering and the like.

In embodiments, the risk criteria occurrence sourcing engine 1108 may be a data source suggestion engine that may additionally take into account data source-specific factors, such as a hit rate for the source (e.g., has the site historically provided useful information, and in particular has it provided actionable information pertinent to the product or service offering for which data sources are being suggested), direct use of the data in the source (e.g., can actionable information be found here that does not require corroboration by other sources and the like), accessibility of the information (e.g., relative to other sites, is actionable information readily accessible or is it obfuscated or generally difficult to detect, such as is the language of the site the same as the criteria derived from the product or service description and the like). The risk criteria occurrence sourcing engine 1108 may produce a list or criteria for data sources to access 1110. This list may include specific URLs and other links to data sources. This list may include criteria, such as search criteria that may be applied in an Internet or the like search for data sources. Analysis of the suggested sources, including those sources found through searching and the like based on the source criteria output by the engine 1108 may be performed and may include accessing the sources (e.g., downloading content from webpages and the like) by a network load aware occurrence analysis engine 1112. This engine 1112 may work cooperatively with website hosting providers and network access nodes to efficiently access for analysis a portion of the suggested data sources 1110. The engine 1112 may provide evaluation of each suggested source as input to the data source suggestion engine 1108, such as if relevant information was found in a specific source and the like. This information, along with other inputs available to the risk criteria occurrence sourcing engine 1108 may be formed into feedback that may be used to improve the information on the risk occurrence source relevance 1106 so that continued use of this system would improve the relevance of the suggested data sources. Such an approach may be performed as a single event for a given business product or service offering, such as when a product or service offering is established by a business. Such an approach may be dynamically and iteratively used to establish a risk associated with offering a business product or service. In an example, an initial suggestion of data sources may be provided based on the description of the business product or service. Based on feedback from the occurrence analysis engine 1112, further data source suggestion may be provided and analyzed in a closed loop that may iterate until a sufficient number of sources of data are found or a confidence that further suggestions will achieve a degree of confidence in the sources of data while not exceeding a computing/network resource utilization threshold.

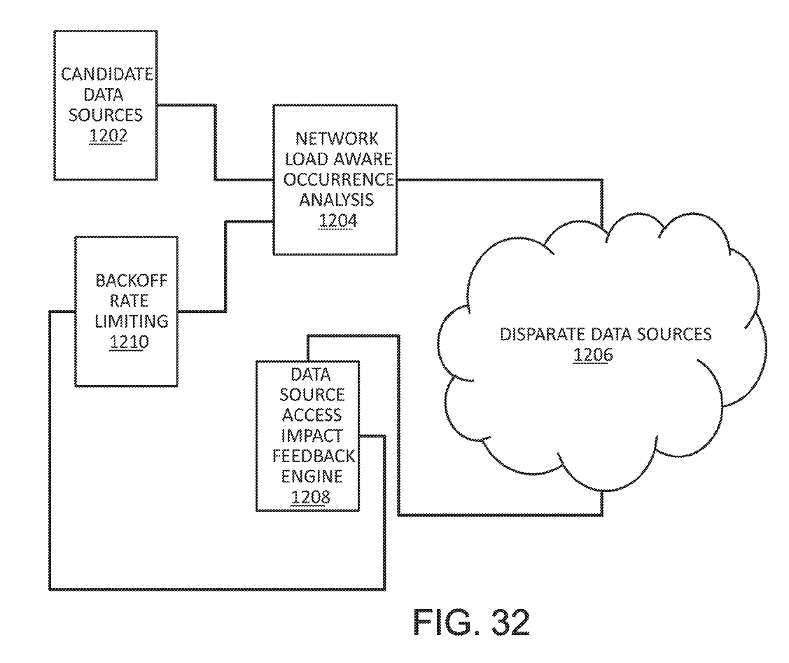

In embodiments, approaches to accessing and analyzing content of data sources, such as Internet-based sources and the like may be resource load aware to optimize those resources to reduce their utilization and increase their productivity for a given business product or service offering risk assessment. In embodiments, FIG. 32 depicts such an approach. Candidate data sources 1202, such as those that may be produced by the risk criteria occurrence sourcing engine 1108 depicted in and described in the disclosure of FIG. 31, may be presented to a computing and network resource load aware occurrence analysis engine 1204. The analysis engine 1204 may incorporate or otherwise take advantage of techniques for utilizing feedback from the data source access impact feedback engine 1208 from computing and/or network accessible resources regarding an impact on those resources caused by the analysis engine 1204 accessing disparate data sources 1206 and the like. In the example of FIG. 32, the data source access impact feedback engine 1208 may be processed by a resource utilization back-off rate limiting facility 1210 that may apply various algorithms to determine factors for accessing the data sources 1206. As the analysis engine 1204 processes data from the sources 1206, network activity may be impacted negatively, including for example, some processing of the data from the sources 1206 may fail for lack of completeness of the data (e.g., a server of the data sources 1206 may be overloaded and cannot process all requests being made, even if the specific request by the analysis engine 1204 is satisfied). This impact may be presented as feedback to the feedback engine 1208 that may determine that a change in how and or when the analysis engine 1204 processed the data sources 1206 is in order. This determination may result in an instruction or at least relevant data about the impact being sent to the rate limiting facility 1210 that may further indicate to the analysis engine 1204 how and/or when to access certain data sources 1206. By incorporating both data access and analysis into this resource utilization/optimization loop, improved occurrence analysis by the analysis engine 1204 will result. Additionally, fewer computing resources will be required due to the improvement in first time success when accessing the data sources 1206.

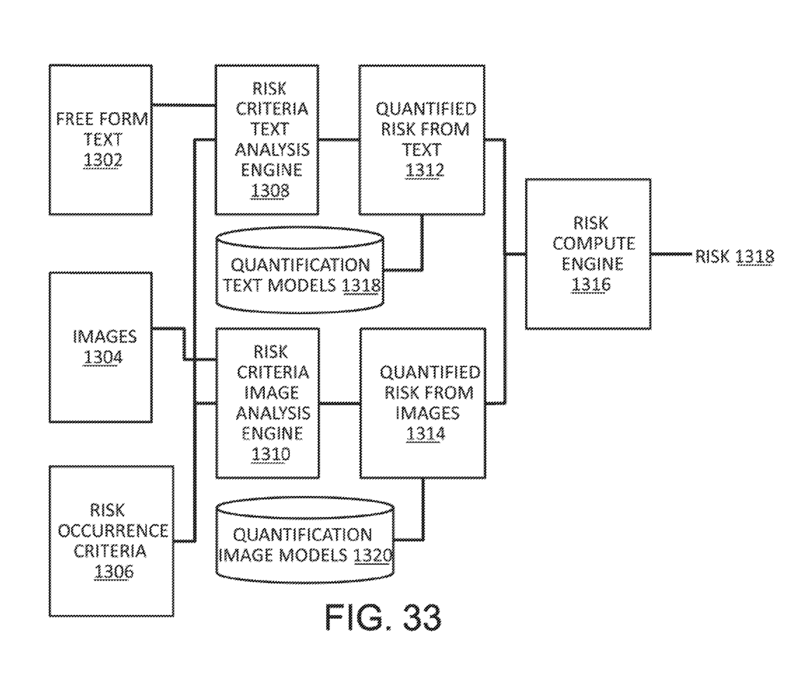

In embodiments, referring to FIG. 33, access, analysis, and processing of data sources, such as those described herein, may be configured to facilitate producing actionable information, such as quantifiable measures of the content in the data sources that is relevant to an offering of a business product or service. Digital content can include free form text (such as embellished descriptions of real world elements and the like), structured text (e.g., listing of features of an asset, such as size, color, material, value, and the like), images and the like. Producing a quantifiable measure of such information may involve techniques described herein including machine learning, NLP, artificial intelligence, keyword extractions, term frequency, term occurrence, confidence of presence of terms/images through corroboration among multiple sources and the like. The result of applying such techniques may further involve determining criteria for such quantification and relevance of such quantification to a risk indicator. Therefore, in the embodiments of FIG. 30, a system for transforming data from a wide range of sources, formats, content types, and relevance to a risk factor is presented. The system as depicted in FIG. 30 may include sources of free-form text 1302, images 1304, and the like that may be processed in accordance with risk occurrence criteria 1306 by risk criteria text analysis engine 1308 to determine measures (e.g., occurrences and mathematical derivations therefrom) of risk criteria found in the text and by risk criteria image analysis engine 1310 to determine measures of risk criteria found in images. The determined measures of text and image risk occurrences may be further processed by quantification engines 1312 (for text) and 1314 (for images). Quantification engines 1312 for text and 1314 for images may rely on quantification models 1318 for text and 1320 for images. However, a range of quantification models 1318 and 1320 may be available for use by the quantification engines based on a range of factors, such as product or service type (e.g., amount being charged/requested for the service versus the value, such as a payout value of the service), target market being served (e.g., market in which a target client requesting the product or service operates), geographic region, competitive offerings, and the like. Selection of an appropriate model may be based on correlation of these factors with parameters associated with the specific instance of execution of the quantification engines. In embodiments, instance of execution factors may be used to adapt one or more quantification models for use therewith.

Operation of the quantification engines 1312 and 1314, for example, may include occurrences of risk criteria and optionally a confidence factor (e.g., a weighting) being processed to generate one or more quantified risk results. These risk results may be generated for each occurrence, for each data source, for each type of occurrence (e.g., for all occurrences of a keyword/phrase), for occurrences with a confidence factor above a confidence factor threshold (to avoid for example, false positives), for occurrences that meet a minimum occurrence count threshold, for a fixed number of occurrences even when a greater number of occurrences are detected, based on a rating or ranking of the data sources (so that data sources that are deemed to have greater relevance are used before sources with lower relevance and the like) and combinations thereof (such as occurrences in a highly ranked data source that have a confidence value above the confidence threshold and the like). Results of this quantification process 1312 and 1314 may include a numeric value, a range of values, a confidence attribute for each outcome, a ranking of the occurrences relative to each other or relative to a predetermined ranking scale, a point along a graph, a graph of values, and the like. Results, such as those described above, may be used as inputs to a risk computation engine 1316 that may generate a measure of risk based on the data sources related to a given product or service offering (e.g., insurance coverage request). Such a measure of risk output from the risk computation engine 1316 may be a singular value, a range of values, a multi-dimensional matrix of values and the like. The risk computation engine 1316 may be preconfigured to produce a specific type of risk output or may be adapted on-the fly based on a range of factors including the outputs from the quantification engines 1312 and 1314, client preferences, offerings of similar products or services from competitors (e.g., a competitiveness factor), and the like. In an insurance product or service offering example, a risk outcome may represent a likelihood of a target business using or seeking to use the product or service filing a claim for workers compensation, disability payout, and the like. Such a likelihood may be a value in a range of values representing a low likelihood to a high likelihood. Such a likelihood may be a matrix of values for a range of time periods, such as within 6 months, 12 months and the like.

While the present disclosure has been described with reference to one or more particular embodiments, those skilled in the art will recognize that many changes may be made thereto without departing from the spirit and scope of the disclosure. Each of these embodiments and many variations thereof are contemplated as falling within the spirit and scope of the disclosure. It is also contemplated that additional embodiments according to the many aspects of the present disclosure may combine any number of features from any of the embodiments described herein.

Detailed aspects of the present teachings are disclosed herein; however, it is to be understood that the disclosed aspects of the present teachings merely exemplary of the disclosure, which may be embodied in various forms. Therefore, specific structural and functional details disclosed herein are not to be interpreted as limiting, but merely as a basis for the claims and as a representative basis for teaching one skilled in the art to variously employ the present disclosure in virtually any appropriately detailed structure.

The terms “a” or “an,” as used herein, are defined as one or more than one. The term “another,” as used herein, is defined as at least a second or more. The terms “including” and/or “having,” as used herein, are defined as “comprising” (i.e., open transition).

While only a few aspects of the present teachings have been shown and described, it will be obvious to those skilled in the art that many changes and modifications may be made thereunto without departing from the spirit and scope of the present disclosure as described in the following claims. All patent applications and patents, both foreign and domestic, and all other publications referenced herein are incorporated herein in their entireties to the full extent permitted by law.

The methods and systems described herein may be deployed in part or in whole through a machine that executes computer software, program codes, and/or instructions on a processor. The present disclosure may be implemented as a method on the machine, as a system or apparatus as part of or in relation to the machine, or as a computer program product embodied in a computer readable medium executing on one or more of the machines. In aspects of the present teachings, the processor may be part of a server, cloud server, client, network infrastructure, mobile computing platform, stationary computing platform, or other computing platform. A processor may be any kind of computational or processing device capable of executing program instructions, codes, binary instructions and the like. The processor may be or may include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor, or any machine utilizing one, may include non-transitory memory that stores methods, codes, instructions and programs as described herein and elsewhere. The processor may access a non-transitory storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In aspects of the present teachings, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server, cloud server, and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks, and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements. The methods and systems described herein may be adapted for use with any kind of private, community, or hybrid cloud computing network or cloud computing environment, including those which involve features of software as a service (SaaS), platform as a service (PaaS), Insight as a Service (InaaS), and/or infrastructure as a service (IaaS).

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, 4G, 5G, EVDO, mesh, or other networks types.

The methods, program codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps associated therewith, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++ or Java, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, methods described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the many aspects of the present teachings shown and described in detail, various modifications and improvements thereon will become readily apparent to those skilled in the art. Accordingly, the spirit and scope of the present disclosure is not to be limited by the foregoing examples but is to be understood in the broadest sense allowable by law.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitations of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

While the foregoing written description enables one skilled in the art to make and use what is considered presently to be the best mode thereof, those skilled in the art will understand and appreciate the existence of variations, combinations, and equivalents of the specific aspects, examples, method, and examples herein. The disclosure should therefore not be limited by the above described aspects, structures, method, and examples, but by all aspects within the scope and spirit of the present teachings.

What is claimed is:

1. A system for computing a risk associated with a product or service offering, the system comprising:
a risk criteria text analysis engine of a computing device configured to process free form text from a plurality of sources of data, wherein the risk criteria text analysis engine is configured to automatically produce from the free form text at least one measure in criteria indicative of a presence of risk;
a risk criteria image analysis engine of the computing device that automatically processes imagery from the plurality of sources of data, wherein the risk criteria image analysis engine is configured to produce from the imagery at least one measure in the criteria indicative of the presence of risk;
a text risk criteria presence quantification engine of the computing device that processes the at least one measure in the criteria indicative of the presence of risk in the free form text with a text quantification model associated with the computing device, wherein the text quantification model is selected from a plurality of text quantification models based on aspects of the product or service offering;
an image risk criteria presence quantification engine of the computing device that processes the imagery readable with the computing device with an image quantification model associated with the computing device, wherein the image risk criteria presence quantification engine automatically determines at least one measure in the criteria indicative of the presence of risk, and wherein the image quantification model is selected from a plurality of image quantification models based on aspects of the product or service offering; and
a risk computation engine of the computing device that automatically quantifies occurrences of the image risk criteria by producing a risk factor based on the at least one measure in the criteria indicative of the presence of risk based on the free form text and the imagery from the plurality of sources of data.

2. The system of claim 1, wherein at least a portion of the imagery from the plurality of sources of data is related to a physical entity.

3. The system of claim 2, wherein the physical entity comprises at least one of a swimming pool, a hot tub, a pet, a trampoline, a workshop or census data for an address of the physical entity.

4. The system of claim 1, wherein at least a portion of the imagery from the plurality of sources of data is related to a description of a good or service provided in a related environment.

5. The system of claim 1, wherein at least a portion of the imagery from the plurality of sources of data is related to a property item.

6. The system of claim 5, wherein the property item is at least one of a swimming pool, a hot tub, a motorcycle, a boat, a deck, a treehouse, a helicopter, a plane, a shed, a workshop, a power tool, or an item of heavy machinery.

7. The system of claim 1, wherein a portion of the imagery from the plurality of sources of data in a related environment includes at least one of an image of a swimming pool, a trampoline, a deck, a shed, an item of heavy machinery, a motorcycle, a boat, a workshop or a set of multiple vehicles at an address of a physical entity.

8. A system for collecting and processing data, the system comprising:
a crawling system of a computing device for collecting the data from at least one public alternative data site; and
an automated data processing system for processing the data collected by the crawling system from the at least one public alternative data site, wherein the automated data processing system is configured to generate at least one risk indicator for use in an insurance system.

9. The system of claim 8, wherein the at least one public alternative data site is at least one of an applicant website, a policyholder website, an applicant social media page, a policyholder social media page, an applicant blog, a policyholder blog, a business rating page regarding an applicant business, a business rating page regarding a policyholder business, a product rating page regarding an applicant product, a product rating page regarding a policyholder product, and an online advertisement by an applicant business, and wherein the at least one risk indicator is used by the computing device to support at least one of targeting an applicant for a sales effort, underwriting an insurance decision, pricing an insurance policy, and monitoring a claim.

10. The system of claim 8, wherein the automated data processing system includes a rules engine, and wherein the automated data processing system automatically applies at least one rule to the data collected by the crawling system to automatically determine the at least one risk indicator relating to at least one of an applicant or a policy holder.

11. The system of claim 8, wherein the automated data processing system of the computing device includes a machine learning system configured to automatically determine at least one risk indicator relating to at least one of an applicant or a policy holder based on the data collected by the crawling system.

12. The system of claim 8, wherein the automated data processing system includes at least one hybrid processing system having at least one rules engine and at least one machine learning system that work in concert to determine at least one risk indicator relating to at least one of an applicant or a policy holder.

13. The system of claim 8, wherein the at least one risk indicator is a business risk score for a defined category of business, and wherein the the data collected by the crawling system is processed based on a nature of the defined category of business associated with the data.

14. The system of claim 13, wherein the defined category of business is at least one of a restaurant business, a retail business, a hotel business, a bar business, a health business, a fitness business, a beauty business, or a spa business.

15. The system of claim 8, wherein the at least one risk indicator is a risk score for a defined category of individual and wherein the data collected by the crawling system is processed based on a nature of the defined category of individual associated with the data.

16. The system of claim 15, wherein the defined category of individual is at least one of a smoker, a non-smoker, a physically active individual, a disabled individual, an injured individual, an employed individual, or an unemployed individual.

17. The system of claim 8, wherein the at least one risk indicator is a risk score for a defined category of insurance and wherein the data collected by the crawling system is processed based on a nature of the defined category of insurance associated with the data.

18. The system of claim 17, wherein the defined category of insurance is at least one of homeowner's insurance, commercial general liability insurance, fire insurance, flood insurance, life insurance, property insurance, health insurance, automotive insurance, motorcycle insurance, boat insurance, or libel insurance.

19. The system of claim 8, further comprising an application programming interface configured to permit at least one of a service, an application or a program to subscribe to the system for collecting and processing data to obtain the at least one risk indicator.

20. The system of claim 19, wherein the application programming interface is configured to permit a subscriber to subscribe to a stream of risk indicators.

21. The system of claim 20, wherein the application programming interface automatically pushes a risk indicator to a user based on a presence of a condition, and wherein the condition is an indicator of a change in risk that exceeds a threshold.

22. The system of claim 8, wherein the data collected by the crawling system is used by the computing device to automatically assess at least one of a likelihood of fraud by an applicant for insurance or a likelihood of fraud by a policyholder.

23. The system of claim 8, wherein the data collected by the crawling system is used by the computing device to automatically populate an insurance application, and wherein the computing device determines the at least one risk indicator by at least combining data from a plurality of the at least one public alternative data sites.
